(19) United States
(12) Patent Application Publication
(10) Pub. No.: US 2010/0177851 A1
(43) Pub. Date: Jul. 15, 2010

(54) COMPENSATION METHOD, PROGRAM, RECORDING MEDIUM, AND RECEIVER FOR OFDM SIGNAL HAVING CFO AND DCO

(75) Inventors: Hai Lin, Osaka (JP); Katsumi Yamashita, Osaka (JP)

Correspondence Address: GREENBLUM & BERNSTEIN, P.L.C., 1950 ROLAND CLARKE PLACE, RESTON, VA, 20191, US

(73) Assignee: OSAKA PREFECTURE UNIVERSITY PUBLIC CORPORATION, Osaka (JP)

(21) Appl. No.: 12/665,455

(22) PCT Filed: Jun. 19, 2008
(86) PCT No.: PCT/JP2008/061202

§ 371 Date: Mar. 11, 2010

(30) Foreign Application Priority Data
Jun. 20, 2007 (JP) 2007-162277

(51) Int. Cl. H04L 25/06; H04L 27/06

(52) U.S. Cl. 375/319; 375/344

(57) ABSTRACT

A frequency offset (CFO) and a direct current component offset (DCO) occur in an OFDM scheme signal. To address this, such a method has been suggested which allows a pilot signal to be mixed with a communicated signal for compensation. However, if the pilot signal has a long duration, then a compensation method without the pilot signal is required to compensate signals during that period. However, no such a method is conventionally available which compensates for both the CFO and DCO without the pilot signal. Using the orthogonality of the OFDM signal, the matrix of a system in which CDO and DCO have occurred is subjected to the singular value decomposition, thereby predetermining the CFO candidate value which allows for demodulating zero from the received signal and an array of numerical values of CFO check data. Then, in a compensation section (17), the received signal is successively multiplied by the numerical values. The typical CFO value provided when the minimum value has been demodulated is outputted as an estimate value for compensation.

### TECHNICAL FIELD

The present invention relates to compensating received signals according to the OFDM (Orthogonal Frequency Division Multiplexing) scheme, and more particularly, to a technique which enables compensation for a carrier frequency offset and a DC offset without a pilot signal.

### BACKGROUND ART

Recently, since the OFDM signal is characterized by having a high transfer rate within a restricted band and being robust against the multipath of a transmitted signal, it has been employed as a variety of communication formats. The OFDM scheme requires strict frequency management because it involves a number of subcarrier signals within a band. Accordingly, some trouble could result during demodulation from a shift in frequency caused between the carrier frequency and the local oscillator of a receiver upon down-conversion or a direct-current offset caused when a higher frequency from the local oscillator is down-converted for the second time.

FIG. 20 shows the cause of occurrence of a frequency offset (hereinafter referred to as “CFO”). The signal transmitting side has a baseband signal (P100), a multiplier (P12), a carrier oscillator (P10) for producing a frequency of f0 as a carrier frequency, an amplifier (P14), and a transmission antenna (P16). The signal (P100) is modulated through a frequency converter, made up of the multiplier (P12) and the carrier oscillator (P10), into a higher frequency, which is then amplified at the amplifier (P14) to be transmitted from the antenna (P16).

On the other hand, the receiving side is made up of a reception antenna (P18), a low-noise amplifier (P24), a multiplier (P22), and a local oscillator (P20) for producing a frequency of f1 as a local oscillation frequency. The is transmitted signal is received at the reception antenna (P18), amplified at the low-noise amplifier (P24), and then down-converted according to the high frequency generated by the local oscillator (P20) into a demodulated signal (P110).

Here, if the carrier frequency f0 on the transmitting side and the local oscillation frequency f1 on the receiving side are the same, no CFO is introduced. However, even a slight difference between f0 and f1 causes a frequency offset (CFO). For example, as shown in the figure, the transmitted signal (P100) has a frequency of f, whereas a decoded signal (P110) has a frequency of f+Δf. This Δf is a CFO.

With reference to FIG. 21, a description will be made on the cause of occurrence of a direct current offset (hereinafter referred to as “DCO”). A receiver (P30) includes a reception antenna (P31), a low-noise amplifier (P32), a multiplier (P33), a local oscillator (P34), a low-pass filter (P35), an A/D converter (P36), and a demodulator (P38).

Here, the high frequency generated by the local oscillator (P34) may be routed through the low-noise amplifier (P32) to the multiplier (P33) (as illustrated with a reference symbol P50 in the figure). Furthermore, an interference wave provided somehow with a great amplitude may become a received signal, which then may intrude into the multiplier (P33) (P40 in the figure).

These cases are equivalent to inputting a signal to the multiplier (P33), where the signal has the same frequency as that generated by the local oscillator for frequency conversion, and is thus reproduced as a direct current component. This is the cause of occurrence of the DCO. The original signal cannot be restored from such a signal with the CFO and DCO occurring at the same time unless the CFO and DCO are compensated for together.

There have been suggested a number of methods for compensating for such CFO and DCO. A method is available to compensate for the CFO using a pilot signal (see Patent Documents 1 and 2).

On the other hand, some methods are available such as a method for integrating the preamble signal of a received signal over time for estimation in order to compensate for the DCO (see Patent Document 3). Another one available is a method for compensating the DCO after the CFO was compensated for using the preamble signal (see Patent Document 4). On the other hand, a method for compensating the CFO without using a pilot signal has also been suggested (Non-Patent Document 1).

[Patent Document 1] Japanese Translation of PCT International Application No. 2004-531168

[Patent Document 2] Japanese Translation of PCT International Application No. 2003-503944

[Patent Document 3] Japanese Patent Application Laid-Open No. 2003-32216

[Patent Document 4] Japanese Patent Application Laid-Open No. 2004-304507

[Non-Patent Document 1] H. Liu and U. Tureli, “A high-efficiency carrier estimator for OFDM communications,” IEEE Commun. Lett., vol.2, pp. 104-106, Apr. 1998

### DISCLOSURE OF THE INVENTION

### Problems to be Solved by the Invention

In order to compensate for the CFO and DCO, such a procedure must be taken in which one of them is first compensated for and the other then compensated for. However, the received signal with both the CFO and DCO occurring at the same time has lost the orthogonality between each subcarrier, and it is thus difficult to properly estimate the CFO and DCO.

In particular, no methods have been conventionally suggested to estimate and compensate for both the CFO and DCO together in the absence of the pilot signal. Such situations may occur not only when the pilot signal has not been transmitted in a transmit and receive system but also when the CFO and DCO are compensated for at some midpoint of the packet with a number of symbols contained in a packet. Accordingly, there has been a challenge that such a method was not conventionally available to estimate and compensate for the CFO and DCO in the absence of the pilot signal. The present invention was developed to address those challenges.

### Means for Solving the Problems

The present invention provides a device and a method for compensating a received signal by estimating and then canceling the received CFO and DCO without using the pilot signal.

That is, the present invention provides a method for compensating an OFDM signal. The method includes the steps of: acquiring data for one symbol of an OFDM received signal; multiplying the data for one symbol by CFO check data selected from multiple sets of prepared CFO candidate values and a set of pieces of CFO check data corresponding to the CFO candidate values; determining the CFO candidate value having a minimum result of the multiplication as a CFO estimate value; and compensating the received signal by a frequency equivalent to the CFO estimate value.

### Effects of the Invention

The present invention allows for sequentially multiplying a received signal by numerical values expressed in a prepared matrix to estimate the total sum of the elements of the resulting matrix, thereby making it possible to estimate and compensate for the most probable CFO. Then, based on the result, the DCO can be estimated and compensated for. Accordingly, even an OFDM scheme signal without a pilot signal defined can be compensated for the CFO and DCO.

### BRIEF DESCRIPTION OF THE DRAWINGS

FIG. 1 is a view illustrating the configuration of a receiver of the present invention.

FIG. 2 is a view illustrating the configuration of a compensation section of the present invention.

FIG. 3 is a view illustrating the configuration of an estimation section of the present invention.

FIG. 4 is an explanatory view illustrating a CFO candidate value and CFO check data.

FIG. 5 is a view illustrating a flow in the estimation section of the present invention.

FIG. 6 is a view illustrating a variation portion of the estimation section flow of the present invention.

FIG. 7 is an explanatory view illustrating how an OFDM signal is created.

FIG. 8 is an explanatory view illustrating a subcarrier.

FIG. 9 is an explanatory view illustrating how the OFDM signal is transmitted and received.

FIG. 10 is an explanatory view illustrating a CFO occurring in the subcarrier.

FIG. 11 is a view illustrating a CFO and DCO occurring in the subcarrier.

FIG. 12 is an explanatory view illustrating the principle of the ME method.

FIG. 13 is a view illustrating a simulation flow of the ANSE method.

FIG. 14 is a view illustrating a simulation flow of the ME method. FIG. 15 is a view illustrating a simulation flow of the ME-TDA method.

FIG. 16 is a view illustrating a simulation result.

FIG. 17 is a view illustrating a simulation result.

FIG. 18 is a view illustrating a simulation result.

FIG. 19 is a view illustrating a simulation result.

FIG. 20 is an explanatory view illustrating the occurrence of a CFO.

FIG. 21 is an explanatory view illustrating the occurrence of a DCO.

### EXPLANATION OF SYMBOLS

10 OFDM receiver of the present application

17 Compensation section

21 Preprocessing section

22 Estimation section

23 Adder section

24 Multiplier section

30 Operational unit

31 ROM

32 RAM

33 Compensation data converter

40 CFO candidate data

44 CFO check data

### BEST MODE FOR CARRYING OUT THE INVENTION

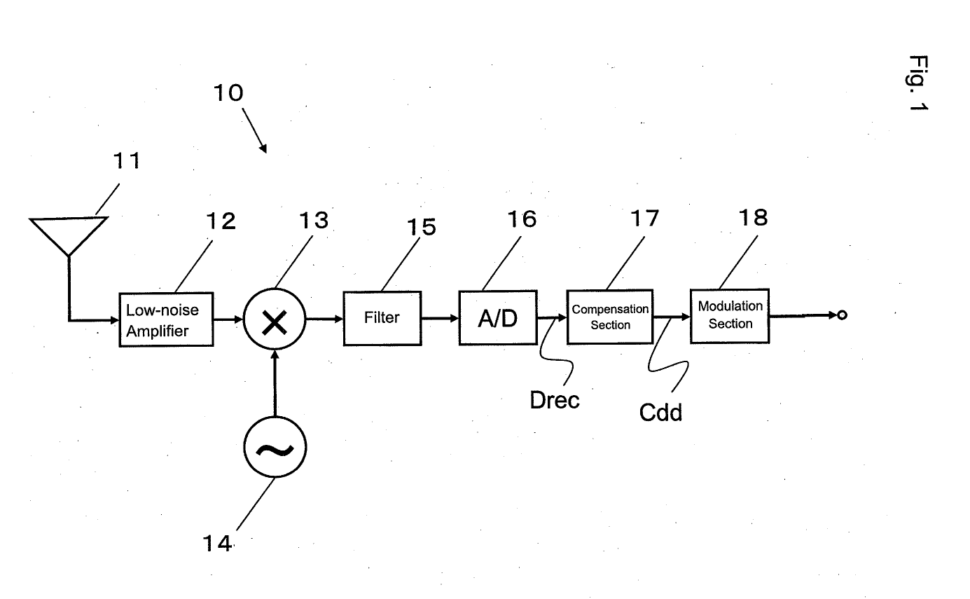

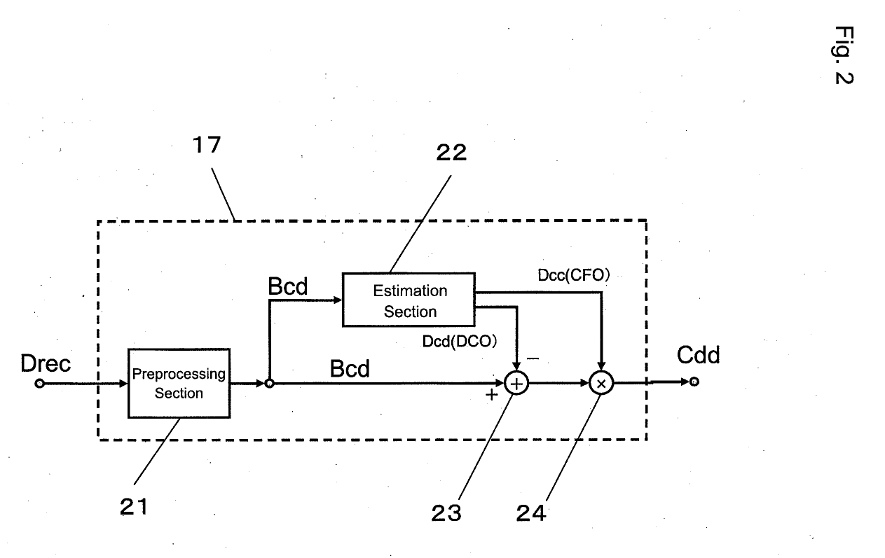

FIG. 1 shows the configuration of a receiver (10) of the present invention. A signal received at an antenna (11) is amplified at a low-noise amplifier (12) and then frequency converted from a carrier band directly to a baseband (direct conversion scheme) at a frequency conversion section that is made up of a mixer (13) and a local oscillator (14). The downconverted signal is eliminated of unwanted high frequency components through a filter (15), and after that, converted at an AD converter (16) to a digital signal as a received signal (Drec).

The received signal (Drec) is processed into a compensated data (Cdd) with the CFO and DCO estimated from the received signal itself having been compensated for by a compensation section (17), and then demodulated at a demodulator section (18). In the present invention, the received signal is an OFDM scheme signal. Accordingly, the demodulator section (18) separates subcarriers through FFT processing, demodulates signals for every subcarrier, and demodulates them through parallel to serial processing. The present invention particularly relates to compensating for the CFO and DCO, which is to be carried out at the compensation section (17).

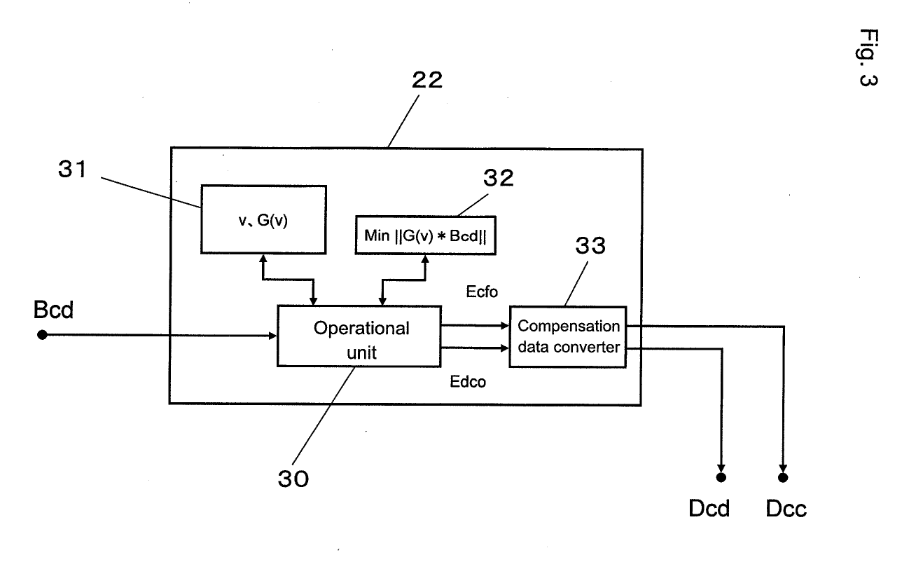

FIG. 2 shows the internal structure of the compensation section (17). The received signal (Drec) is inputted to a preprocessing section (21) to remove the cyclic prefix portion. The cyclic prefix refers to such an initial portion of a symbol period of the OFDM scheme signal that has an overlapping part of symbol period data. This is attached to the transmitted signal on the transmitting side in order to remove interference between the blocks.

As used herein, the term “removing” means processing including not only simple deletion but also reproducing the symbol signal using them. Accordingly, the preprocessing section (21) outputs a symbol signal of before-compensation data (Bcd).

The before-compensation data (Bcd) is inputted to an estimation section (22). The estimation section (22) estimates the value of the CFO and DCO to output CFO compensation data (Dcc) and DCO compensation data (Dcd).

The DCO compensation data (Dcd) is added to the before-compensation data (Bcd) at an adder (23) to compensate for the DC offset. Then, the resulting data is multiplied by CFO compensation data at a multiplier (24) to yield the compensated data (Cdd) with the carrier offset (CFO) compensated for. Note that compensating is based here on the CFO and DCO estimated from the received signal in accordance with the present invention, so that it does not mean compensating without error but includes error in the range of the estimation.

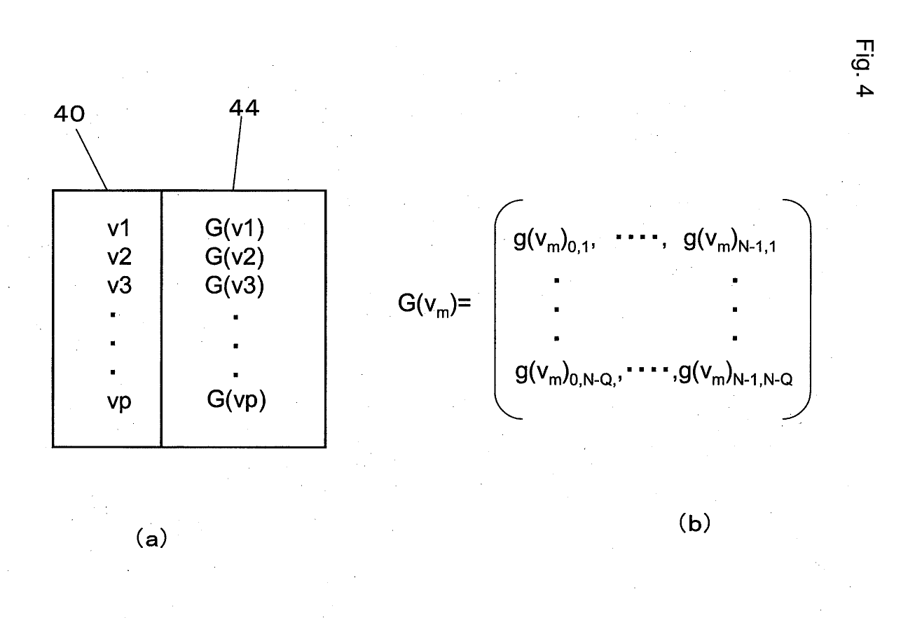

FIG. 3 shows the internal layout of the estimation section (22). The estimation section (22) has an operational unit (30), a ROM (31) for storing groups of pre-calculated data, a RAM (32) for retaining calculation results, and a compensation data converter (33) for converting them to compensation data to compensate for the estimated CFO and DCO.

A computation section (30) holds the before-compensation data (Bcd) inputted to multiply matrix data or G(v) by the before-compensation data (Bcd) successively. The multiplication here means to determining the product of the matrices. The results are recorded on the RAM (32). Then, when the result recorded on the RAM (32) is at the minimum, the DCO compensation data (Dcd) and the CFO compensation data (Dcc) is calculated for output.

FIG. 4(a) shows more specific contents of the data stored on the ROM (31). The data is stored in pairs of a CFO candidate value (40) and CFO check data (44). The CFO candidate value (40) is a frequency normalized with a subcarrier interval to take on numerical values from −1.0 to 1.0. That is, the CFO is assumed not to exceed the interval between subcarriers. However, if the subcarrier deviation is an integer multiple of the subcarrier interval, the present application cannot implement compensation; however, if the deviation is not an integer multiple, then the compensation is possible. Note that FIG. 4 indicates that the CFO candidate value v can have β values.

The CFO candidate value (40) divides the subcarrier interval to ensure the required resolution. For example, an interval of 0.01 is to divide the range from −1.0 to 1.0 into 200 divisions. In contrast to this, FIG. 4(b) shows the CFO check data (44). This represents the CFO check data corresponding to the mth CFO candidate value v. The CFO check data (44) is a matrix with the minimum 1×N to the maximum (N−Q−1)×N for one CFO candidate value (40). N is the number of divisions of one symbol (the number of samples in one symbol) as well as the total number of subcarriers. The CFO check data (44) is represented by a matrix G(v). Furthermore, a G₁(v) and a G₂(v) also represent CFO check data.

The CFO check data (44) is pre-calculated based on the signal band and the number of subcarriers in the OFDM system of interest and the CFO candidate value (40). As the number of columns of the matrix of the CFO check data (44) increases, calculation accuracy is increased as well but with an increase in the amount of calculation. Accordingly, the size of the CFO check data (44) is to be determined as appropriate at the time of system design.

Referring back to FIG. 3, the operational unit (30) retains pre-corrected data (Bcd) to be sequentially multiplied by the matrix G(v). More specifically, the matrices of the CFO check data (44) and the pre-corrected data (Bcd) are multiplied by each other to find its product. That is, this becomes a vector quantity. The norm of the resulting vector is to be the scalar quantity of the results. More specifically, the norm is the square root of the sum of the square of each component of the resulting vector obtained by the product of the aforementioned matrices.

Because this calculation is intended to obtain the CFO candidate value when the calculation result is at the minimum as described below, simply the sum of the square of each component of the resulting vector may also represent the value. In FIG. 3, the CFO check data G(v) (44) and the pre-corrected data (Bcd) are linked with the mark “*” to thereby represent the product of matrices and surrounded by vertical double lines to represent the norm. The same representation will be employed hereinafter. By taking the norm, the matrix G(v)*Bcd becomes a scalar quantity. Furthermore, “Min” represents taking the minimum value.

The CFO candidate value (40) paired with the CFO check data (44) by which the least one of these scalar quantities can be obtained is the estimated quantity Ecfo of CFO. Furthermore, it is possible to determine the estimate value Edco of DCO based on the CFO. Then, the compensation data converter (33) is used to determine the CFO compensation data (Dcc) for cancelling the CFO and the DCO compensation data (Dcd) for cancelling the DCO, for output. Hereinafter, the CFO compensation data and DCO compensation data will be referred to collectively as compensation data.

Subsequently, as described with reference to FIG. 2, the adder (23) and the multiplier (24) are used to compensate for the CFO and DCO. Note that in the present application, the average value of the symbols in the before-compensation data (Bcd) may be estimated as the DCO to be compensated for. On the other hand, since the compensation data converter (33) serves only to invert the sign of the estimated CFO and DCO, the computation section (30) can play the role of the compensation data converter (33).

In this manner, according to the present invention, the pre-corrected data (Bcd) is sequentially multiplied by the CFO check data (44) or numerical value data predetermined by calculation, thereby allowing the CFO candidate value (40) corresponding to the CFO check data (44) to be estimated as the CFO when the calculation result is at the minimum. The DCO is also determined by calculation based on the CFO. The method for calculating the matrix G(v) to compute the estimate values of the CFO and DCO and the method for calculating the DCO will require mathematical descriptions and will be discussed in detail later.

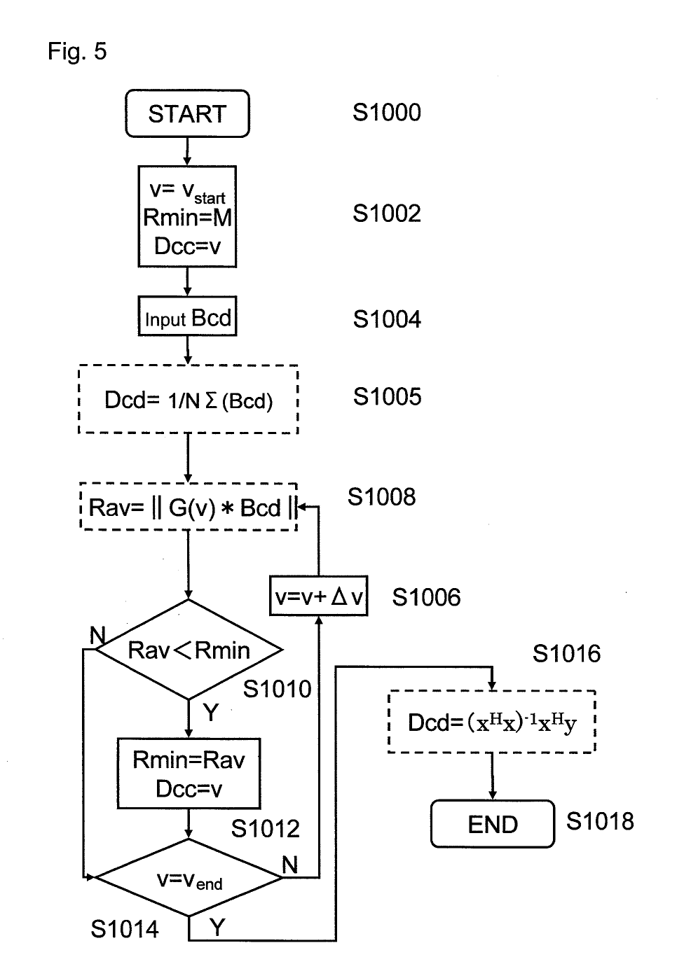

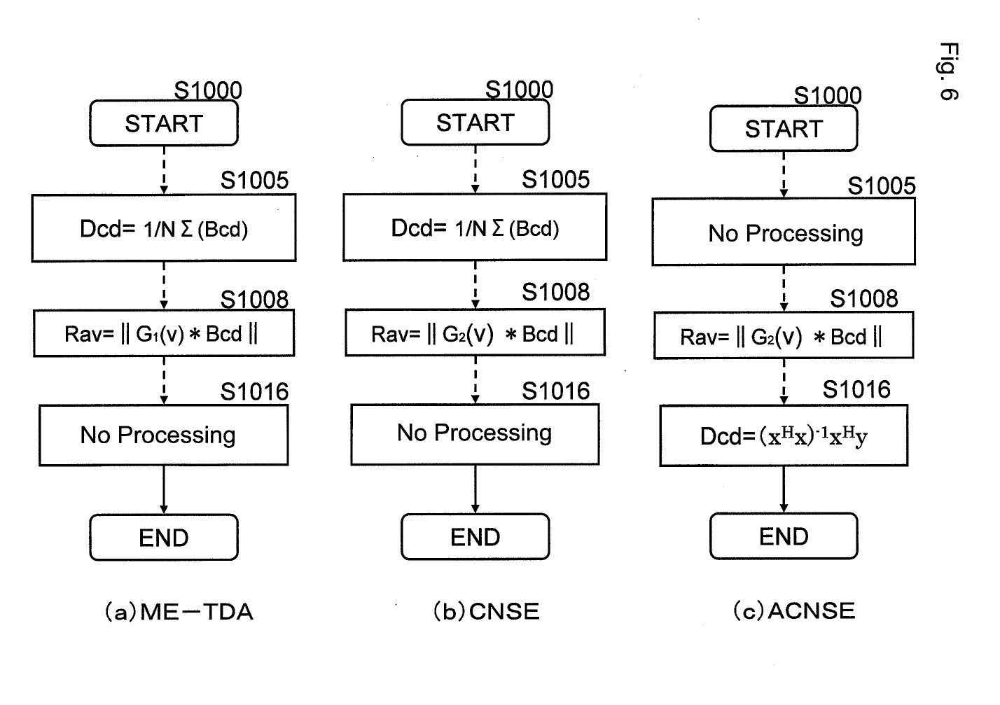

FIG. 5 shows the process flow followed by the operational unit (30) of FIG. 3. This process flow can be conducted during every symbol period of the OFDM scheme signal. It is of course acceptable to operate the compensation data determined during the symbol period on multiple symbol signals to be later received.

When this process flow starts (S1000), preparation processing (S1002) is performed. Here, the values v, Rmin, and Dcc are initialized. The value “v” is a CFO candidate value (40). The value “v” is set to an initial value vₛₜᵣₐₜ. Rmin is a variable for determining the minimum of the calculation results. Accordingly, a very large number M is initially given, and for example, may be a real numerical value equal to or greater than 1. Dcc is the CFO compensation data to be determined here.

When the before-compensation data (Bcd) is entered (S1004), the norm of the product of the matrices of the initial CFO check data G(v) and the before-compensation data (Bcd) is calculated as Rav (S1008). Here, for convenience of description, one step was skipped over. Rav is calculated as an absolute value because its minimum absolute value is employed as the CFO compensation data. Of course, its square value may also be calculated.

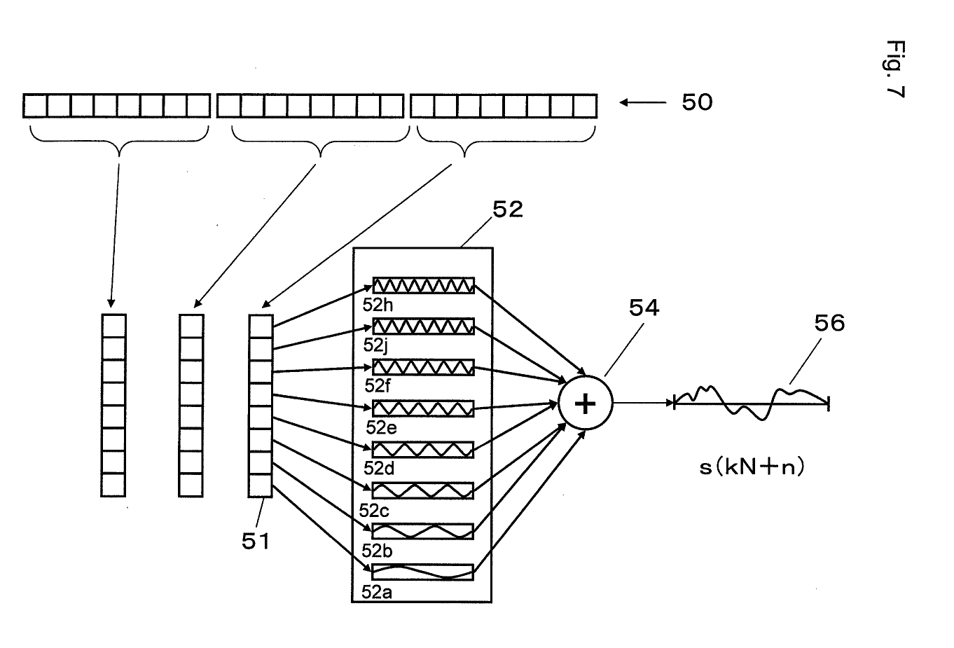

Note that the present invention provides several compensation methods, which are different from each other, so that the differences cause the step (S1005), step (S1008), and step (S1016) to perform processing differently. Although a detailed description will be given with reference to FIG. 6, these steps were each framed with dotted lines to explicitly represent this fact.

The Rav and Rmin calculated here are compared with each other (S1010), so that if the Rav is smaller, then the Rav is employed as a new Rmin (S1012). Furthermore, the “v” at this time is recorded as the Dcc. If the Rav is larger, then this step is skipped (the N branch of S1010). The process checks if the value “v” is the final v (=v_{end}) (S1014); if it is not the final one, then the value “v” is incremented (S1006), and the process returns to step (S1008) (the N branch of S1012).

When the process has completely checked the final v or the v_{end}, the value “v” recorded on Dcc at that time is the CFO compensation data that can cancel the CFO. Then, a predetermined calculation is performed based on this Dcc (S1016). This predetermined calculation can provide the value of the DCO when the CFO is compensated for. The value of the DCO when the CFO is compensated for is the DCO compensation data Dcd described with reference to FIG. 1. The specific contents of the predetermined calculation will be discussed using Equations 55 to 57 to be discussed later. Note that if the step (S1005) is performed, then the step (S1016) will not be carried out.

FIG. 6 explicitly illustrates those portions that are changed by the processing in FIG. 5 due to the compensation method according to the present invention. The present invention provides three compensation methods such as an ME-TDA method, a CNSE method, and an ACNSE method, and in their respective cases, the portions different from those of FIG. 5 are shown in FIG. 6. Three steps are changed: step (S1005), step (S1008), and step (S1016). The other portions are omitted using dotted line arrows.

In the step (S1005), such processing is performed in which the average value of each piece of the before-compensation data (Bcd) is employed as the DCO compensation data (Dcd), so that the Dcd is subtracted from each value of the before-compensation data. The DCO compensation data (Dcd), which is the average value of each piece of data of the before-compensation data (Bcd), will be described in detail with reference to Equation 32. In the ME-TDA method, the step (S1005) is performed, while in the step (S1008), CFO check data or the matrix G₁(v) is used, and thus the step (S1016) is not executed. That is, in the ME-TDA method, the average value of each piece of the before-compensation data (Bcd) is employed as the DCO compensation data (Dcd), while the CFO is estimated based on the CFO check data or the G₁(v). Note that the indication “no processing” found in step (S1016) is synonymous with “skipped”.

In the CNSE method, the step (S1005) is performed, and the step (S1008) uses the CFO check data or the matrix G₂(v), skipping the step (S1016). That is, the average value of each piece of the before-compensation data (Bcd) is employed as the DCO compensation data (Dcd), while the CFO is estimated based on the CFO check data or the G₂(v). Note that the matrix G₁(v) and the matrix G₂(v) are CFO check data that is obtained based on different technical concepts and thus cannot be used in the same compensation method.

Furthermore, in the ACNSE method, the process skips the step (S1005), while in the step (S1008), the CFO check data or the matrix G₂(v) is used to execute the step (S1016). That is, the CFO is estimated based on the CFO check data or the G₂(v), while the DCO compensation data (Dcd) is determined in the step (S1016). Here, x and y can be determined by a certain column vector, and the DCO compensation data (Dcd) can be determined by the least square method from x and y. A detailed description will be made on the step (S1016) with reference to Equations 55 to 57.

Note that the aforementioned processing may be performed by the MPU running on a software program written in an appropriate description language or implemented by hardware logic circuits fabricated as an IC. Furthermore, the program may be held in a memory device within the receiver or retained in an external storage and then called up into the receiver as appropriate to be executed.

### DETAILED DESCRIPTION

In the OFDM scheme transmission method, the information to be transmitted is carried in a number of subcarriers that are orthogonal to each other. This can be expressed mathematically by linear algebra. Here, consider an OFDM communication system with N subcarriers. S_{k,m} is assumed to represent the kth symbol of the mth subcarrier in the OFDM system designed for QAM or PSK. Then, the signal s(kN+n) to be transmitted is expressed as in Equation 1. Note that mathematical equations are herein is mentioned as “Equation 1.”

$$\begin{matrix}[ EQ 1 ] & \\ s ( kN + n ) = \frac{1}{\sqrt{N}} {\sum }_{m = 0}^{N - 1} {S}_{k , m} {e}^{j \frac{2 π n m}{N}} , n = 0 , 1 , 2 , … , N - 1. & ( 1 )\end{matrix}$$

Where n means N divisions of one period of a subcarrier having a frequency of 2n/N, equivalent to time. Suppose that such a signal is transmitted and as a result, received in the form of Equation 2.

$$\begin{matrix}[ EQ 2 ] & \\ r ( kN + n ) = \frac{1}{\sqrt{N}} {\sum }_{m = 0}^{N - 1} {S}_{k , m} {H}_{m} {e}^{j ( \frac{2 π n ( m + e )}{N} + {φ}_{k} )} + z ( kN + n ) , \\ n = 0 , 1 , 2 , … , N - 1. & ( 2 )\end{matrix}$$

Where Hm is the channel frequency response of the mth subcarrier, and represents the effects, resulting from it having been transmitted through space, such as distortions or temporal delays. The ε represents a normalized CFO in a manner such that Δf or CFO has been normalized with respect to a subcarrier interval f. The subcarrier interval refers to the frequency interval between the center frequency of a subcarrier and the center frequency of an adjacent subcarrier. The second term on the right-hand side is white noise with its center value at zero and a variance of σ².

This can be expressed in a matrix as in Equation 3 below. Hereinafter, the matrix will be expressed in boldface type in a mathematical equation, while in sentences, it is expressed with the term “matrix” attached in front thereof such as in “matrix A”.

r(k)=e^{jφ}^{ₖ}Γ_{N}(ε)F_{N}d_{N}(k)+z(k) (3)

Here, each term and each variable on the right-hand side are as given below.

[EQ 4]

φₖ=2πε·k(N+N_{cp})/N (4)

In Equation 4, Ncp is a cyclic prefix period. Accordingly, φₖ is equivalent to a phase shift caused by the cyclic prefix in the presence of the CFO. The cyclic prefix is transmitted during a guard interval period and provided to alleviate the effects of multipath on the delayed reception. That is, even when a delay is caused due to multipath, the presence of cyclic prefix can ensure the orthogonality between each subcarriers. In the descriptions below, φₖ will be omitted.

$$\begin{matrix}[ EQ 5 ] & \\ {F}_{N} = \frac{1}{\sqrt{N}} [ \begin{matrix}1 & {e}^{j \frac{2 π \cdot 1 \cdot 0}{N}} & … & … & {e}^{j \frac{2 π \cdot ( N - 1 ) \cdot 0}{N}} \\ 1 & {e}^{j \frac{2 π \cdot 1 \cdot 1}{N}} & & & {e}^{j \frac{2 π \cdot ( N - 1 ) \cdot 1}{N}} \\ ⋮ & & ⋱ & & ⋮ \\ ⋮ & & & ⋱ & ⋮ \\ 1 & {e}^{j \frac{2 π \cdot 1 \cdot ( N - 1 )}{N}} & … & … & {e}^{j \frac{2 π \cdot ( N - 1 ) \cdot ( N - 1 )}{N}}\end{matrix} ] & ( 5 )\end{matrix}$$

Equation 5 represents a matrix F_{N}. The matrix F_{N} is an N×N IDFT (Inverse Discrete Fourier Transform) matrix. Each column is equivalent to a subcarrier. Multiplying this matrix F_{N} from the left side means a modulation into an OFDM signal.

The elements in the first column of the matrix F_{N} in Equation 5 are all 1/√N, representing DC components. In the

OFDM scheme, since the DC component cannot be sent as a signal, the data corresponding to this carrier is always zero. Furthermore, in each column, the exponential portion becomes larger towards the right, so that the sign of the exponential portion is considered to be minus when 2π(N−1)/N exceeds n. That is, the right columns of the IDFT matrix in Equation 5 show a negative frequency portion.

Note that in the matrix, the vertical line is called a column, while the horizontal line is called a row. Furthermore, the size of the matrix is expressed by the number of rows×the number of columns. That is, a matrix of M×N has M rows and N columns. However, a matrix with only one horizontal row or only one vertical column is a vector. Accordingly, a 1×N matrix is a horizontal vector (row vector) with N elements arranged side by side, while an N×1 matrix is a vertical vector (column vector) with N elements arranged vertically. Note that those matrices may also be herein referred to as a row matrix and a column matrix, respectively.

This matrix F_{N} can also be written as in Equation 6 below.

[EQ 6]

F_{N}=[f₀, f₁i , . . . , f_{N-1}] (6)

The respective matrices fₖ (from k=0 to N−1) represent the column matrix (column elements) of Equation 5.

In particular, the matrix f₀ is expressed as in Equation 7. Here, the matrix a column vector with all the elements being 1.

[EQ 7]

f₀=a/√N (7)

Note that in the OFDM system, all the subcarriers are not used, and some subcarriers are transmitted as null signals. Assuming that substantially Q carriers serve to carry signals, Equation 8 can be given as below.

[EQ 8]

W_{Q}=[w₁, w₂, . . . , w_{Q}] (8)

This sequentially shows those of N subcarriers which carry no null, each matrix w being an N×1 column matrix.

The remaining subcarriers carrying null signals can be explicitly expressed as in Equation 9 below.

[EQ 9]

W_{⊥}=[w_{Q+1}, w_{Q+2}, . . . , w_{N}] (9)

This shows subcarriers carrying null signals arranged in sequence. With Equations 8 and 9 defined in this manner, the matrix F_{N} and the matrix W shown in Equation 6 have subcarriers arranged differently. Note that the matrix W is a matrix with the matrix W_{Q} and the matrix W_{⊥} arranged in this order.

Here, the matrix w_{Q+1} is to represent a DC portion. That is, it is the matrix f₀ of the IDFT matrix shown in Equation 6. Accordingly, the matrix w_{Q+1} is a column matrix with all elements being 1/√N. Furthermore, those other than the matrix w_{Q+1} are indicated as the matrices w_{Q+i}, which are subcarriers carrying null data.

For example, consider an OFDM transmission system with subcarriers being eight in number. Then, Equation 6 is expressed specifically as Equation 10.

[EQ 10]

F_{N}=[f₀, f₁, f₂, f₃, f₄, f₅, f₆, f₇] (10)

Here, assuming subcarriers carrying null are matrices f₀, f₃, f₄, and f₅, the matrices W_{Q} and W_{⊥} are expressed as in Equations 11 and 12.

[EQ 11]

W_{Q}=[w₁, w₂, w₃, w₄]32 [f₁, f₂, f₆, f₇] (11)

[EQ 12]

W_{⊥}=[w₅, w₆, w₇, w₈]=[f₀, f₃, f₄, f₅] (12)

$$\begin{matrix}[ EQ 13 ] & \\ {Γ}_{N} ( ɛ ) = diag ( 1 , {e}^{j \frac{2 π e}{N}} , … , {e}^{j \frac{2 π e ( N - 1 )}{N}} ) & ( 13 )\end{matrix}$$

The matrix Γ_{N}(ε) shown in Equation 13 represents a matrix of ε that is the carrier frequency offset (CFO). It is assumed that the same carrier frequency offset (CFO) occurs on all the subcarriers. The “diag” represents a diagonal matrix. That is, in the matrix Γ_{N}(ε), only the diagonal elements of the N×N matrix have values with all other elements being zero.

[EQ 14]

d_{N}(k)=[H₀S_{k,0}, H₁S_{k,1}, . . . , H_{N-1}S_{k,N-}]^{T} (14)

The matrix d_{N}(k) shown in Equation 14 depicts the transmitted signal S_{k,m} having received a channel frequency response. Hₖ (k=0 to N−1) is a coefficient which represents the frequency response of respective subcarriers. The “T” on the right shoulder of the braces on the right-hand side shows the transposed matrix (hereinafter the same holds true).

[EQ 15]

z(k)=[z(kN), z(kN+1), . . . , z(kN+N−1)]^{T} (15)

The matrix z(k) shown in Equation 15 depicts other noise components, assumed to have the Gaussian distribution. The noise component will not be required for the description of the present application, and thus will be omitted in the explanations below. However, it will be used for the evaluations by simulation to be described later.

The matrix r(k) or a received signal shown in Equation 3 eventually becomes a 1×N column matrix, which is expressed as in Equation 16 below.

[EQ 16]

r(k)=[r(kN), r(kN+1), . . . , r(kN+N−1)]^{T} (16)

The matrix r(k) is the kth OFDM symbol received at the receiver. Equation 16 shows that the matrix r(k) has data of one cycle of 2n/N (N pieces of data in all) or a fundamental wave.

Based on the preparations given above, the ideal received signal with no noise or CFO can be expressed as in Equation 17 below.

[EQ 17]

r(k)=F_{N}d_{N}(k)=W_{Q}d_{Q}(k) (17)

Furthermore, the received signal with CFO is expressed as in Equation 18 below.

[EQ 18]

r(k)=Γ_{N}(ε)W_{Q}d_{Q}(k) (18)

The matrix W_{⊥} is null data and thus can be eliminated, and only the matrix W_{Q} can be employed for the expression. Furthermore, the received signal having the CFO and DCO occurring together is expressed as below.

[EQ 19]

r(k)=Γ_{N}(ε)W_{Q}d_{Q}(k)+βa (19)

In Equation 19, β is a DCO component. The matrix a, shown in Equation 7, is a column matrix with all elements being one.

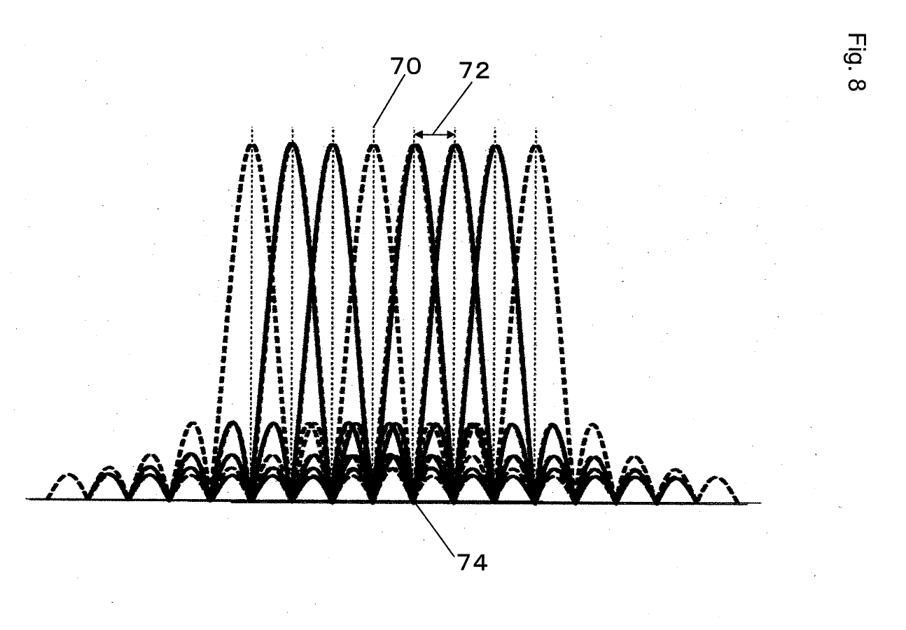

The foregoing arguments will be now described with reference to the drawings. For simplicity of explanation, assume eight carriers. FIG. 7 is a simplified explanatory view illustrating how the OFDM signal is created. A signal sequence S (50) to be sent is a digital signal. One square box represents one piece of data. This signal sequence S (50) is divided into blocks, each having multiple pieces of data. In FIG. 7, it was divided into blocks of eight pieces of data. Then, the IDFT processing was performed on the respective pieces of data block by block. Note that the IDFT processing, as referred to herein, may be replaced with the IFFT processing. This is because the IFFT processing is intended to accelerate the operation of the IDFT processing, and the same results can be obtained.

Here, assume that the kth data block is Sₖ(51). Sₖ is a block having eight pieces of data. The IDFT processing section (52) has eight sub-subcarrier oscillators. FIG. 7 shows that it has eight subcarrier oscillators (from 52a to 52h) with frequencies being two, three, four, . . . , and eight times the fundamental wave frequency.

This processing of the IDFT processing section (52) is the matrix F_{N} of Equation 5. The data of Sₖ(51) is modulated with the respective subcarriers, and then added together at a subsequent adder (54). The result obtained by the addition is a signal (56), which is the s(kN+n) or the transmitted signal in Equation 1. Concerning the transmitted signal (56), the horizontal axis represents time and the vertical axis represents the signal strength.

In summary, the signal sequence S (50) to be transmitted is called one-symbol signal. The unit of the square boxes that constitute one-symbol signal is called one sample, which may be made up of multiple bits. Each sample is allocated to a predetermined frequency and then modulated, and thereafter subjected to the IDFT processing to produce the transmitted signal (56). This transmitted signal (56) is also called one-symbol signal.

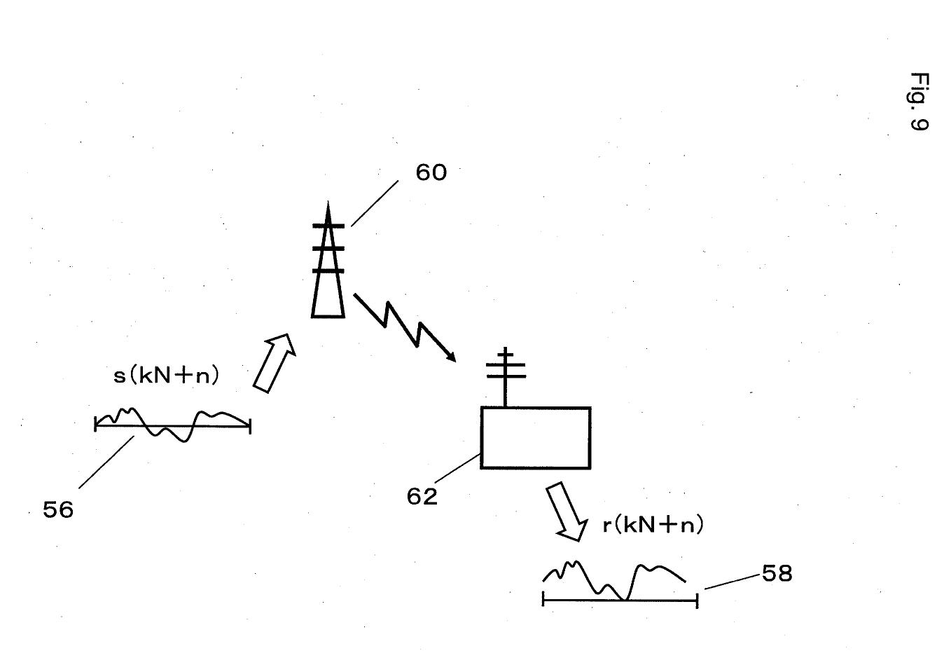

FIG. 8 is a view showing the transmitted signal (56). The horizontal axis represents the frequency. The vertical axis represents the signal strength. Here, the vertical axis takes on any unit. In FIG. 8, the subcarrier depicted with a solid line carries information, whereas the subcarrier shown with a dotted line carries null.

The 4th subcarrier (70) from the left has zero frequency, representing the DC component. When it is actually transmitted, it is frequency converted with a carrier frequency, and a subcarrier (70) has a carrier frequency. Adjacent subcarriers are shifted by f(72) or a frequency interval. Subcarriers are orthogonal to each other, so that the cyclical points of harmonic components are each overlapped (for example, the points of a symbol 74). FIG. 8 shows Equation 1 on the frequency axis. Note that each subcarrier is shown separately though it is a signal with these signals added together.

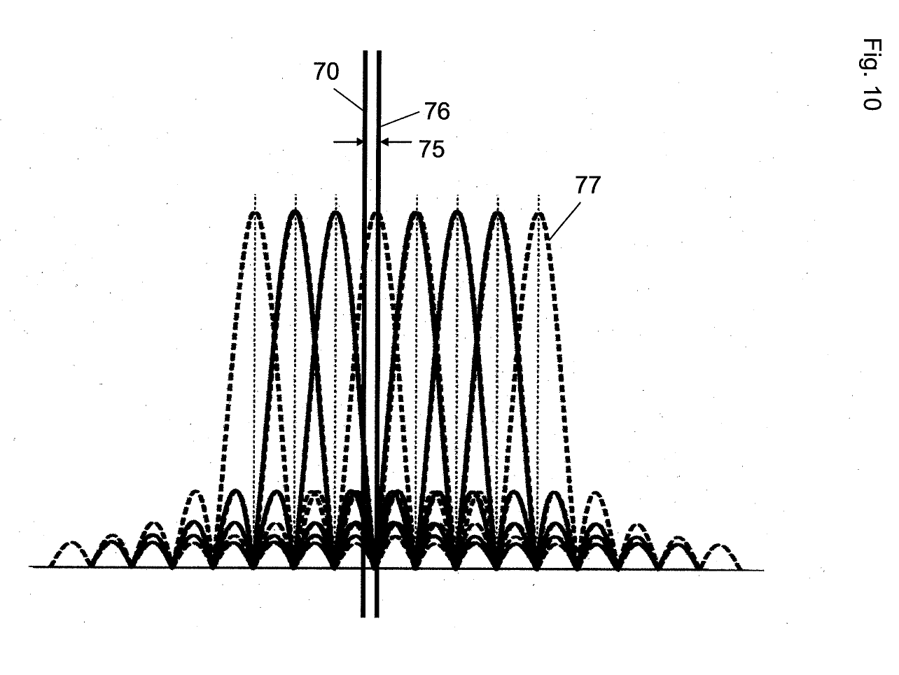

FIG. 9 shows the entire transmission system. A transmission station (60) frequency converts the transmitted signal (56) with a carrier, and then outputs the resulting signal. A reception station (62) receives the signal and then frequency converts it to the baseband; however, it demodulates the resulting signal as a received signal (58) that contains errors such as DC offsets or frequency offsets due to the effects of transmission paths or sneaking from the local oscillator of the receiver itself.

This received signal (58) is r(kN+n) in Equation 2. For the received signal (58), assuming that any subcarrier has received the same channel frequency response, the absolute frequency value may have been shifted but the signal seen on the frequency axis takes on the same shape as that shown in FIG. 8. Accordingly, an ideal received signal with neither CFO nor DCO has the same frequency characteristics as those of the transmitted signal of FIG. 8. This ideal received signal corresponds to Equation 17.

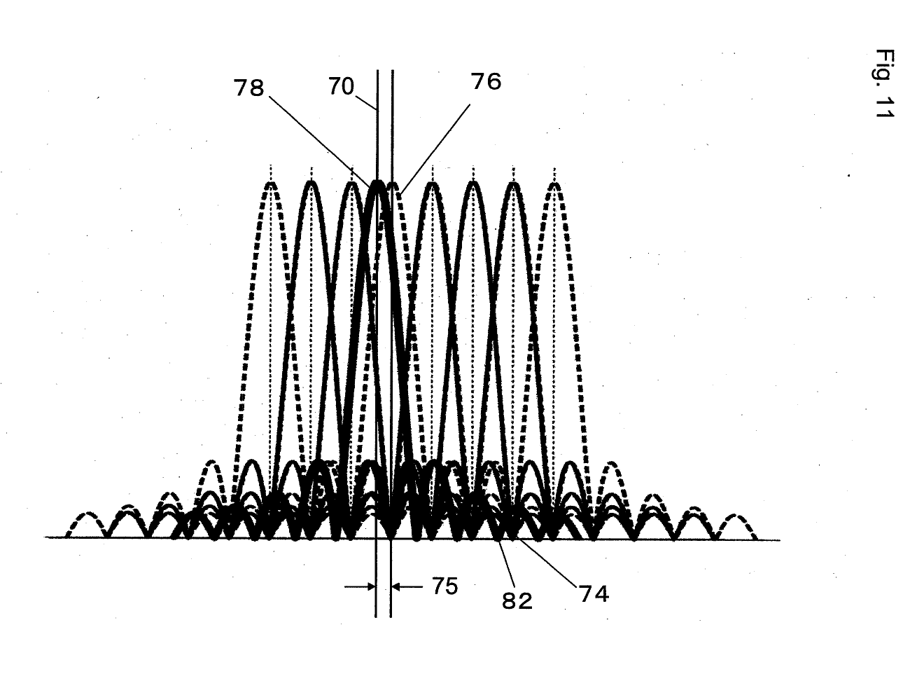

FIG. 10 shows that only CFO has occurred on the ideal received signal. It is shifted in frequency by Δf (75) from point (70) at a frequency of zero. The Δf is divided by the subcarrier interval f to obtain a value ε. Furthermore, the operation for allowing the ideal received signal Equation 17 to shift by ε corresponds to multiplying Equation 17 by the matrix of Equation 13 from the left.

Here, it is assumed that the same amount of CFO has occurred on all the subcarriers. This is because the CFO is caused by a slight discrepancy between the local oscillator on the transmitting side and the local oscillator on the receiving side, and thus, the same error occurs on all the subcarriers upon frequency conversion. The received signals on which only CFO has occurred are expressed by Equation 18.

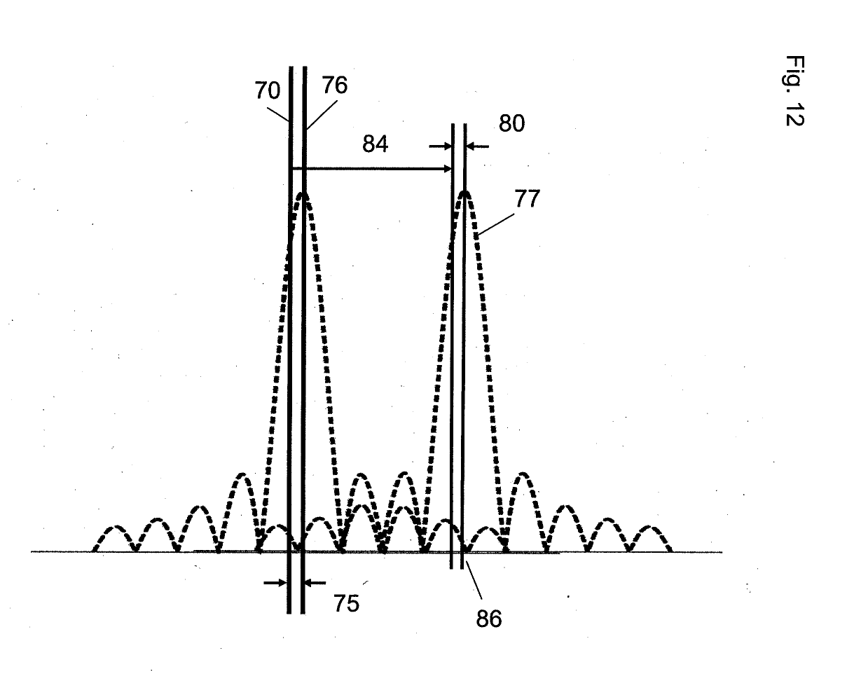

FIG. 11 shows that DCO occurred as well. The horizontal axis shows the frequency and the vertical axis shows the strength. The vertical axis is arbitrary. The signal (78) shown with a bold solid line in the frequency zero (70) portion is the DCO. The subcarriers excluding the DCO have CFO occurring thereon, with the subcarrier (76) at frequency zero being shifted from the frequency zero (70). As shown in FIG. 10, this deviation (75) is if.

The actual signal is the sum of these signals. That is, the CFO and DCO occur and are added to the relation between subcarriers which are originally orthogonal to each other. The DCO thus occurred has been shifted from the subcarriers having the orthogonal relation to each other. Accordingly, the occurrence of only CFO has already caused the loss of the orthogonality of subcarriers, and all the more, the occurrence of DCO causes a zero point (82) to occur at a different point than the point (74) where the subcarriers in a mutual orthogonal relation will have zero components. Accordingly, the received signal (58) or the sum of these signals is now a signal having lost orthogonality. The signal having lost orthogonality is the signal shown by Equation 19.

Now, a brief description will be made on the determinant. Each column of the matrix F_{N} indicative of the IDFT processing shown by Equation 5 represents subcarriers. These subcarriers are orthogonal to each other, so that the inner product of different subcarriers is zero. For example, the inner product of the Pth and Rth subcarriers is always zero when P and R are different from each other. This relation is expressed in Equation 20.

[EQ 20]

f_{P}^{H}f_{R}=0 (20)

In Equation 20, the H on the right shoulder of the matrix f_{P} on the first term on the left-hand side shows a conjugate transposed matrix of the matrix f_{P}. The conjugate transposed matrix is formed in a manner such that when the elements of the matrix are complex numbers, each element is conjugated to be turned into a transposed matrix. With P=R, it has the relation shown by Equation 21.

[EQ 21]

f_{P}^{H}f_{P}=1 (21)

The relation can be used to enable the following. The matrix r(k) which is an ideal received signal shown in Equation 17 is made up of a plurality of subcarriers. An example is the signal as shown in FIG. 7. Since these subcarriers are orthogonal to each other, multiplying the ideal received signal of Equation 17 by the conjugate transposed matrix of a signal of any subcarrier from the left would make it possible to acquire only the subcarrier component. In other words, only that subcarrier component can be demodulated. This represents nothing but the demodulation operation of an actual tuner.

For example, the matrix representing the IDFT processing shown in Equation 5 has a subcarrier carrying a null signal. These subcarriers are shown in Equation 9. Let one of the subcarriers be the matrix w_{Q+i}. This having been applied to the ideal received signal of Equation 17 is expressed as in Equation 22.

[EQ 22]

W_{Q+i}^{H}r(k)=w_{Q+i}^{H}W_{Q}d_{Q}(k)=0, i=1, 2, . . . , N−Q (22)

No matrix w_{Q+i} components are found in the matrix W_{Q} and the matrix d_{Q}(k) on the right-hand side, and thus can be said to be zero. Even if the matrix F_{N} takes the place of the matrix W_{Q}, the transmitted signal is zero and thus expressed as in Equation 22. That is, if a subcarrier carrying null is determined in advance, the inner product of the ideal received signal and that subcarrier can be taken, thereby ensuring that zero be always derived from the received signal. Using such a relation, a description will be made below on the method for estimating the CFO and DCO.

<Compensation Assuming the Presence of only CFO (ME Method)>

Now, a discussion will be made on the compensation of CFO when only CFO is present on the ideal received signal. This is an estimation method similar to the so-called MUSIC (Multiple Signal Classification) method in which in the technical field of antenna, the cost function is determined while changing the angle of antenna in order to determine the incoming direction of radio waves, thereby determining the angle at which the cost function is the minimum or maximum (H. Liu and U. Tureli, “A high-efficiency carrier estimator for OFDM communications,” IEEE Commun. Lett., vol.2, pp. 104-106, Apr. 1998).

Accordingly, this estimation method is called a MUSIC-like estimation method (ME method). The ideal received signal overlapped with CFO is as shown in Equation 18. This can also be illustrated in FIG. 10. Equation 18 is shown again below.

[EQ 23]

r(k)=Γ_{N}(ε)W_{Q}d_{Q}(k) (18)

Where ε is CFO with Δf normalized by the subcarrier interval.

Equation 18 shows a received signal matrix r(k) where the entire signal is frequency shifted by ε. The presence of CFO will not cause it to be zero even when the subcarrier carrying null can be demodulated as in Equation 22. That is, it is expressed as in Equation 23.

[EQ 24]

w_{Q+i}^{H}r(k)=w_{Q+i}^{H}Γ_{N}(ε)W_{Q}d_{q}(k) ≠0, i=1, 2, . . . , N−Q (23)

This is because each subcarrier is shifted by ε and thus HₖS_{k,Q+i} is not successfully demodulated even when it is multiplied by the frequency of the subcarrier, and thus it is not null or zero.

Consider the operation as below to be performed on such a received signal having such a CFO. This is the operation which causes all the subcarriers to be frequency shifted by v, and is just opposite to the operation which causes the carrier frequency offset to be frequency shifted by frequency ε.

$$\begin{matrix}[ EQ 25 ] & \\ {E}_{N} ( v ) = diag ( 1 , {e}^{- j \frac{2 π v}{N}} , … , {e}^{- j \frac{2 π v ( N - 1 )}{N}} ) & ( 24 )\end{matrix}$$

This Equation 24 is operated on Equation 18 which is assumed to have only CFO to check the component of a subcarrier carrying a null signal, so that Equation 25 is given below when ε=v.

[EQ 26]

w_{Q+i}^{H}E_{N}(v)r(k)=w_{Q+i}^{H}E_{N}(v)Γ_{N}(ε)W_{Q}d_{Q}(k)=0, i=1, 2, . . . , N−Q (25)

The matrix Γ_{N}(ε) and the matrix E_{N}(v) have the same shape of diagonal matrix with different signs in the exponential portion. Each element of the inner product of the matrix Γ_{N}(ε) and the matrix E_{N}(v) can be explicitly expressed as in Equation 26.

$$\begin{matrix}[ EQ 27 ] & \\ \begin{matrix}{E}_{N} ( v ) {Γ}_{N} ( ɛ ) = diag ( 1 , {e}^{- j \frac{2 π v}{N}} , … , {e}^{- j \frac{2 π v ( N - 1 )}{N}} ) \\ diag ( 1 , {e}^{j \frac{2 π ɛ}{N}} , … , {e}^{j \frac{2 π ɛ ( N - 1 )}{N}} ) \\ = diag ( 1 , {e}^{j \frac{2 π ( ɛ - v )}{N}} , … , {e}^{j \frac{2 π ( ɛ - v ) ( N - 1 )}{N}} )\end{matrix} & ( 26 )\end{matrix}$$

As can be seen from this Equation 26, when ε=v, (ε−v) found in the multiplication portion of the matrix E_{N}(v) and the matrix Γ_{N}(ε) becomes zero cancelling the CFO, thereby yielding the same results as in Equation 17 in the ideal status with no offset. At this time, from mathematical viewpoints, this means that the inner product of the matrix E_{N}(v) and the matrix Γ_{N}(ε) becomes a matrix with its all diagonal components being one and the other element being zero, or a unit matrix.

The matrix w_{Q+i} and the matrix E_{N}(v) on the left-hand side of Equation 25 can be calculated in advance for each different v. The matrix w_{Q+i} is a subcarrier carrying null, and the matrix E_{N}(v) can be pre-calculated and thus prepared at certain intervals. Accordingly, the received signal matrix r(k) can be multiplied successively by the inner product of the matrix w_{Q+i} and the matrix E_{N}(v) determined for each v. When its result has become zero or the closet to zero, the CFO at this time can be estimated to be v. In this manner, it is possible to estimate CFO without the pilot signal. This is the ME method. In this case, Equation 25 is used as the cost function.

Now, the estimation method according to the ME method will be discussed more specifically. Suppose that the transmission system has eight subcarriers that follow Equation 10, Equation 11, and Equation 12. In this case, the matrix E_{N}(v) is a matrix E₈(v). The subcarriers carrying null are the matrix w₅, the matrix w₆, the matrix w₇, and the matrix w₈. Here, the matrix w₆ or a subcarrier carrying null is selected to determine the inner product with the matrix E₈(v). Note that another matrix can also be selected so long as it is a subcarrier carrying null. This is specifically expressed in Equation 27.

$$\begin{matrix}[ EQ 28 ] & \\ \begin{matrix}{w}_{6}^{ℋ} {E}_{8} ( v ) = {f}_{3}^{ℋ} {E}_{8} ( v ) \\ = [ {e}^{- j \frac{2 π \cdot 0 \cdot 3}{8}} , {e}^{- j \frac{2 π \cdot 1 \cdot 3}{8}} , … , {e}^{- j \frac{2 π \cdot 7 \cdot 3}{8}} ] \\ diag ( 1 , {e}^{- j \frac{2 π v}{8}} , … , {e}^{- j \frac{2 π v 7 }{8}} ) \\ = [ {e}^{- j \frac{2 π \cdot 0 \cdot ( 3 + v ) \cdot }{8}} , {e}^{- j \frac{2 π \cdot 1 \cdot ( 3 + v )}{8}} , {e}^{- j \frac{2 π \cdot 7 \cdot ( 3 + v )}{8}} ]\end{matrix} & ( 27 )\end{matrix}$$

On the other hand, the matrix r(k) serving as the received signal takes the form as shown in Equation 28 below.

$$\begin{matrix}[ EQ 29 ] & \\ \begin{matrix}r ( k ) = \frac{1}{\sqrt{8}} [ \begin{matrix}{e}^{j \frac{2 π ɛ \cdot 0}{8}} & 0 & … & 0 \\ 0 & {e}^{j \frac{2 π ɛ \cdot 1}{8}} & … & 0 \\ ⋮ & ⋮ & ⋱ & ⋮ \\ 0 & 0 & … & {e}^{j \frac{2 π ɛ \cdot 7}{8}}\end{matrix} ] \\ [ \begin{matrix}{e}^{j \frac{2 π \cdot 1 \cdot 0}{8}} & {e}^{j \frac{2 π \cdot 2 \cdot 0}{8}} & {e}^{j \frac{2 π \cdot 6 \cdot 0}{8}} & {e}^{j \frac{2 π \cdot 7 \cdot 0}{8}} \\ {e}^{j \frac{2 π \cdot 1 \cdot 1}{8}} & {e}^{j \frac{2 π \cdot 2 \cdot 1}{8}} & {e}^{j \frac{2 π \cdot 6 \cdot 1}{8}} & {e}^{j \frac{2 π \cdot 7 \cdot 1}{8}} \\ ⋮ & ⋮ & ⋮ & ⋮ \\ {e}^{j \frac{2 π \cdot 1 \cdot 7}{8}} & {e}^{j \frac{2 π \cdot 2 \cdot 7}{8}} & {e}^{j \frac{2 π \cdot 6 \cdot 7}{8}} & {e}^{j \frac{2 π \cdot 7 \cdot 7}{8}}\end{matrix} ] [ \begin{matrix}{H}_{1} {S}_{k , 1} \\ {H}_{2} {S}_{k , 2} \\ {H}_{6} {S}_{k , 6} \\ {H}_{7} {S}_{k , 7}\end{matrix} ] \\ = \frac{1}{\sqrt{8}} [ \begin{matrix}{e}^{j \frac{2 π ɛ \cdot 0}{8}} & 0 & … & 0 \\ 0 & {e}^{j \frac{2 π ɛ \cdot 1}{8}} & … & 0 \\ ⋮ & ⋮ & ⋱ & ⋮ \\ 0 & 0 & … & {e}^{j \frac{2 π ɛ \cdot 7}{8}}\end{matrix} ] \\ [ \begin{matrix}{\sum }_{m = 1 , 2 , 6 , 7} {e}^{j \frac{2 π \cdot m \cdot 0}{8}} \cdot {H}_{m} \cdot {S}_{k , m} \\ {\sum }_{m = 1 , 2 , 6 , 7} {e}^{j \frac{2 π \cdot m \cdot 1}{8}} \cdot {H}_{m} \cdot {S}_{k , m} \\ ⋮ \\ {\sum }_{m = 1 , 2 , 6 , 7} {e}^{j \frac{2 π \cdot m \cdot 7}{8}} \cdot {H}_{m} \cdot {S}_{k , m}\end{matrix} ] \\ = \frac{1}{\sqrt{8}} [ \begin{matrix}{e}^{j \frac{2 π ɛ \cdot 0}{8}} {\sum }_{m = 1 , 2 , 6 , 7} {e}^{j \frac{2 π \cdot m \cdot 0}{8}} \cdot {H}_{m} \cdot {S}_{k , m} \\ {e}^{j \frac{2 π ɛ \cdot 1}{8}} {\sum }_{m = 1 , 2 , 6 , 7} {e}^{j \frac{2 π \cdot m \cdot 1}{8}} \cdot {H}_{m} \cdot {S}_{k , m} \\ ⋮ \\ {e}^{j \frac{2 π ɛ \cdot 7}{8}} {\sum }_{m = 1 , 2 , 6 , 7} {e}^{j \frac{2 π \cdot m \cdot 7}{8}} \cdot {H}_{m} \cdot {S}_{k , m}\end{matrix} ]\end{matrix} & ( 28 )\end{matrix}$$

In the third row of Equation 28, all elements contains ε. That is, there is a frequency shift of ε across all subcarrier symbols. Here, for a certain range of v, Equation 27 is calculated as Equation 29 below.

$$\begin{matrix}[ EQ 30 ] & \\ \begin{matrix}{w}_{6}^{ℋ} {E}_{8} ( 0.50 ) = {f}_{3}^{ℋ} {E}_{8} ( 0.50 ) \\ = [ \begin{matrix}{e}^{- j \frac{2 π \cdot 0 \cdot ( 3 + 0.50 )}{8}} , {e}^{- j \frac{2 π \cdot 1 \cdot ( 3 + 0.50 )}{8}} , … , \\ {e}^{- j \frac{2 π \cdot 7 \cdot ( 3 + 0.50 )}{8}}\end{matrix} ] \\ {w}_{6}^{ℋ} {E}_{8} ( 0.49 ) = {f}_{3}^{ℋ} {E}_{8} ( 0.49 ) \\ = [ \begin{matrix}{e}^{- j \frac{2 π \cdot 0 \cdot ( 3 + 0.49 )}{8}} , {e}^{- j \frac{2 π \cdot 1 \cdot ( 3 + 0.49 )}{8}} , … , \\ {e}^{- j \frac{2 π \cdot 7 \cdot ( 3 + 0.49 )}{8}}\end{matrix} ] \\ ⋮ \\ ⋮ \\ {w}_{6}^{ℋ} {E}_{8} ( - 0.5 ) = {f}_{3}^{ℋ} {E}_{8} ( - 0.5 ) \\ = [ \begin{matrix}{e}^{- j \frac{2 π \cdot 0 \cdot ( 3 - 0.50 )}{8}} , {e}^{- j \frac{2 π \cdot 1 \cdot ( 3 - 0.50 )}{8}} , … , \\ {e}^{- j \frac{2 π \cdot 7 \cdot ( 3 - 0.50 )}{8}}\end{matrix} ]\end{matrix} & ( 29 )\end{matrix}$$

Note that 0.5 or 0.49 are those that have been normalized with the subcarrier interval, and the division width (0.01) shown above is to be determined as appropriate at the time of system design. When the compensation for frequency offsets is taken into consideration, it is sufficient to consider a frequency offset up to half the subcarrier band. Accordingly, as described above, for the v of the matrix E_{N}(v), the range from 0.5 to −0.5 has to be only divided with the required accuracy. This corresponds to the division width.

The received signal is successively multiplied by the numerical values that have been prepared in this manner. The “multiplication” here means to calculate the inner product. A specific calculation is shown in Equation 30.

$$\begin{matrix}[ EQ 31 ] & \\ {w}_{Q + i}^{ℋ} {E}_{N} ( 0.50 ) r ( k ) \\ {w}_{Q + i}^{ℋ} {E}_{N} ( 0.49 ) r ( k ) \\ ⋮ \\ ⋮ \\ {w}_{Q + i}^{ℋ} {E}_{N} ( - 0.5 ) r ( k ) & ( 30 )\end{matrix}$$

Then, the v that gives the minimum value among these calculation results is to be estimated as CFO. This calculation is meant to perform the operation below.

FIG. 12 shows only the rightmost and middle subcarriers extracted from those of FIG. 10. The CFO is shown as Δf (75). In this case, it is assumed that the matrix w_{Q+i} in Equation 30 is the subcarrier of a symbol (77) in FIG. 10, this subcarrier is known to carry null.

Let the center frequency of this subcarriers be fₙᵤₗₗ (84). Then, the actual frequency of the subcarrier (77) is fₙᵤₗₗ+Δf (86). Accordingly, even when the received signal matrix r(k) is multiplied by the frequency fₙᵤₗₗ (84) of this subcarrier in an attempt to decode the signal component, the null signal cannot be extracted due to the shift by the CFO.

However, multiplying the received signal by the subcarrier, while its center frequency is being shifted little by little, makes it possible to obtain such a point at which the extracted signal is zero or the closest to zero at a frequency of fₙᵤₗₗ+Δf. The operation of Equation 30 is nothing but the operation for exploring such a if. In this case, the resolution corresponds to the resolution of e; for example, in the aforementioned case, it is the frequency equivalent to the subcarrier interval f×0.01.

In this manner, when only CFO is present in the received signal, the CFO can be estimated as described above, and the estimated amount of CFO can be compensated for, thereby allowing for obtaining the received signal with no offset. However, in practice, there is no possibility that only CFO is present in the received signal, but the DCO is present at the same time. It is thus necessary to make a compensation by taking the DCO into account as below.

<CFO Estimation Method with DCO Cancelled (ME-TDA Method)>

Now, a description will be made on a method of compensating for CFO with the DCO cancelled in an approximate manner. In the presence of DCO with an offset quantity of β, the received signal can be expressed as in Equation 19. Equation 19 is shown below again.

[EQ 32]

r(k)=Γ_{N}(ε)W_{Q}d_{Q}(k)+βa (19)

Now, the matrix E_{N}(v) indicative of the operation of compensating the matrix r(k) or the received signal from the left for the CFO is multiplied by the matrix w_{Q+i} or a carrier of null as shown below. This corresponds to the operation of decoding the subcarrier carrying null signals while the subcarriers are being slightly shifted.

[EQ 33]

w_{Q+i}^{H}E_{N}(v)r(k)=w_{Q+i}^{H}E_{N}(v) Γ_{N}(ε)W_{Q}d_{Q}(k)+w_{Q+i}^{H}E_{N}(v)βa, i=1, 2, . . . , N−Q. (31)

In Equation 31, the second term on the right-hand side represents the DC offset component. The matrix E_{N}(v) represents a frequency shift less than half the subcarrier band, while the conjugate transposed matrix of the matrix w_{Q+i} is a frequency shift greater than the subcarrier band. Furthermore, since the matrix a is a column matrix with all the elements being one, the second term on the right-hand side which is the inner product of them is in general to be zero. Accordingly, the presence of this component, as with the CFO estimation (the ME method) in which DCO is not taken into account, does not allow the left-hand side of Equation 31 to be zero by calculation even if v is varied. In this context, it is considered that the DC component is eliminated. Of course, the amount of DC component is not known.

Here, consider the feature of the OFDM signal. In the OFDM, the total sum of data during one symbol period is always zero. The reason why the total sum of the actually received signal data is not zero is because of the effects of the CFO and DCO. Although to what extent the DCO has effects on the total sum of the actual signal data is not known, the average of signals over one symbol period is still thought to be not greatly different from that of the DCO component.

In this context, consider the operation in which the average of signals over one symbol period in the signal of Equation 19 is determined, and the resulting value is subtracted from the direct current component, thereby eliminating it. The average of signals over one symbol period is expressed by Equation 32 below.

$$\begin{matrix}[ EQ 34 ] & \\ \begin{matrix}\overline{r} ( k ) = \frac{1}{N} {a}^{ℋ} ( {Γ}_{N} ( ɛ ) {W}_{Q} {d}_{Q} ( k ) + β a ) \\ = \frac{1}{N} {a}^{ℋ} {Γ}_{N} ( ɛ ) {W}_{Q} {d}_{Q} ( k ) + β\end{matrix} & ( 32 )\end{matrix}$$

The left-hand side term of Equation 32 shows the average value of the matrix r(k) (hereinafter referred to as “average value r(k)”). Multiplication of the conjugate transposed matrix of the matrix a from the left corresponds to the operation of accumulating signal components over the symbol period. That is, it is multiplied from the left by an N×1 matrix with all its elements being one. Since the matrix a is √N times the DC component of the IDFT but has all the elements being one, the N×1 matrix with all the elements being one is represented by this matrix. Accordingly, the average of the matrix r(k) is a scalar quantity. That is, the average value r(k) is a scalar quantity. Furthermore, considering that the matrix a has N elements, the relation expressed by Equation 33 below was employed.

[EQ 35]

a^{H}a=N (33)

Now, in place of the received signal matrix r(k), a matrix Ψ(k) is defined below. The matrix Ψ(k) was derived by subtracting the direct current component from the received signal so that only CFO is apparently present. This is shown specifically in Equation 34 below.

$$\begin{matrix}[ EQ 36 ] & \\ \begin{matrix}Ψ ( k ) = r ( k ) - a \overline{r} ( k ) \\ = {Γ}_{N} ( ɛ ) {W}_{Q} {d}_{Q} ( k ) + β a - \frac{1}{N} {aa}^{ℋ} {Γ}_{N} ( ɛ ) {W}_{Q} {d}_{Q} ( k ) - β a \\ = ( {I}_{N \times N} - \frac{1}{N} {aa}^{ℋ} ) {Γ}_{N} ( ɛ ) {W}_{Q} {d}_{Q} ( k ) \\ = {Ω}_{N} {Γ}_{N} ( ɛ ) {W}_{Q} {d}_{Q} ( k )\end{matrix} & ( 34 )\end{matrix}$$

Here, the matrix Ω_{N} was defined as Equation 35 below.

$$[ EQ 37 ]$$

$${Ω}_{N} = {I}_{N \times N} - \frac{1}{N} {aa}^{ℋ} \qquad ( 35 )$$

Accordingly, the matrix Ω_{N} is an N×N matrix with the diagonal elements being “1−1/N” and the other elements being “−1/N”.

The average value r(k) is multiplied by the matrix a in Equation 34 because it is to be treated as a matrix. That is, the average value r(k) is subtracted from all pieces of received data over the symbol period. Here, the matrix Ω_{N} has been introduced as a matrix for eliminating the direct current component. By performing the aforementioned operation, the DCO component or β needs not to be taken into account. In the first term on the right-hand side of Equation 35, I is the unit matrix or an N×N square matrix. The second term on the right-hand side of Equation 35 is also an N×N square matrix because the N×l column matrix is multiplied by the 1×N row matrix. Furthermore, these matrices are the product of the matrix a and the transposed matrix of the matrix a, and thus a matrix with all the elements being one.

Such a matrix Ψ(k) takes a form that has absorbed the direct current component term by the determinant; however, there is no change in the signal band itself. Since it has the matrix Γ_{N}(ε), the matrix Ψ(k) still has the same CFO (=ε) as that of the matrix r(k).

At a glance of this Equation 34, it seems that the ME method can be applied. That is, it seems that the Equation below may be zero at v=ε when v is varied in different manners.

[EQ 38]

w_{Q+i}^{H}E_{N}(v)Ψ(k)=w_{Q+i}^{H}E_{N}(v)Ω_{N}Γ_{N}(ε)W_{Q}d_{Q}(k) (36)

In Equation 36, the average value r(k) of data over the symbol period is regarded as being DCO and used for the subtraction. It can be thus said that this method has been improved from the aforementioned ME method in which no consideration was made on the DCO. For this reason, this method is called the ME-TDA (MUSIC-Like-Estimator by a Time-Domain Average) method.

To actually employ the ME-TDA method, Equation 36 is modified into the form as below. The matrix r(k) of Equation 19 multiplied by the matrix Ω_{N} of Equation 35 can be expressed as in Equation 37 below.

[EQ 39]

Ω_{N}r(k)=Ω_{N}Γ_{N}(ε)W_{Q}d_{Q}(k)+βΩ_{N}a (37)

Here the second term on the right-hand side is expressed as in Equation 38 below.

$$\begin{matrix}[ EQ 40 ] & \\ \begin{matrix}β {Ω}_{N} a = β ( {I}_{N \times N} a - \frac{1}{N} {aa}^{ℋ} a ) \\ = β ( a - a ) \\ = 0\end{matrix} & ( 38 )\end{matrix}$$

Therefore, Equation 37 is expressed as in Equation 39 below.

[EQ 41]

Ω_{N}Γ(k)=Ω_{N}Γ_{N}(ε)W_{Q}d_{Q}(k) (39)

This relation is applied to Equation 36. This is specifically shown in Equation 40.

[EQ 42]

w_{Q+i}^{H}E_{N}(v)Ψ(k)=w_{Q+i}^{H}E_{N}(v)Ω_{N}Γ_{N}(ε)W_{Q}d_{Q}(k)=w_{Q+i}^{H}E_{N}(v)Ω_{N}Γ(k) (40)

The matrix w_{Q+i} is a subcarrier carrying null and thus known in advance. The matrix E_{N}(v) is also as discussed in relation to the ME method, and thus can be determined with the predetermined interval width.

For the matrix Ω_{N}, its size and elements can be readily known from Equation 35 if the number of data divisions N is known. The matrix r(k) is the received signal itself. Accordingly, like the ME method, the operation can be implemented by successively multiplying the received signal by pre-calculated pieces of data. That is, by employing Equation 40 as the cost function, the device configured as in FIG. 3 can implement the ME-TDA method.

Taking the same specific example as Equation 29 for explanation, the matrix w_{Q+i} and the matrix E_{N}(v) are the same as Equation 29, and the matrix Ω_{N} can be determined by Equation 35. Accordingly, those that are pre-calculated are the numerical values calculated by Equation 41 below.

$$\begin{matrix}[ EQ 43 ] & \\ {w}_{6}^{ℋ} {E}_{8} ( 0.50 ) {Ω}_{8} = [ \begin{matrix}{e}^{- j \frac{2 π \cdot 0 \cdot ( 3 + 0.50 )}{8}} , {e}^{- j \frac{2 π \cdot 1 \cdot ( 3 + 0.50 )}{8}} , … , \\ {e}^{- j \frac{2 π \cdot 7 \cdot ( 3 + 0.50 )}{8}}\end{matrix} ] {Ω}_{8} \\ {w}_{6}^{ℋ} {E}_{8} ( 0.49 ) {Ω}_{8} = [ \begin{matrix}{e}^{- j \frac{2 π \cdot 0 \cdot ( 3 + 0.49 )}{8}} , {e}^{- j \frac{2 π \cdot 1 \cdot ( 3 + 0.49 )}{8}} , … , \\ {e}^{- j \frac{2 π \cdot 7 \cdot ( 3 + 0.49 )}{8}}\end{matrix} ] {Ω}_{8} \\ ⋮ \\ ⋮ \\ {w}_{6}^{ℋ} {E}_{8} ( - 0.5 ) {Ω}_{8} = [ \begin{matrix}{e}^{- j \frac{2 π \cdot 0 \cdot ( 3 - 0.50 )}{8}} , {e}^{- j \frac{2 π \cdot 1 \cdot ( 3 - 0.50 )}{8}} , … , \\ {e}^{- j \frac{2 π \cdot 7 \cdot ( 3 + 0.50 )}{8}}\end{matrix} ] {Ω}_{8} & ( 41 )\end{matrix}$$

Note that the matrix Ω_{N} is an N×N square matrix with the diagonal elements being “1−1/N” and the other elements being “−1/N”. Accordingly, the calculation result of the right-hand side of each equation is an N×l row matrix. To implement this in the device of FIGS. 2 to 3, the aforementioned respective equations may be substituted by the CFO check data (44) of FIG. 4. That is, the processing flow of FIG. 5 may be executed as the matrix G₁(v) shown in the processing flow(a) of FIG. 6.

In this manner, the processing for estimating CFO as with the ME method can be determined; however, since the matrix Ω_{N} of Equation 40 is constant irrespective of v, Equation 40 serving as the cost function will primarily never become zero. That is, the ME-TDA method seemed to be able to employ the ME method at a glance in Equation 34, but there is still insufficiency in the accuracy of estimation though it has been improved from the ME method.

This resulted from the fact that the average value r(k) of data over the symbol period, which was assumed to be close to DCO, was subtracted from the received signal, causing the orthogonality between the OFDM subcarriers to be broken upon creation of signals; nevertheless, the ME method was forcedly employed. The Dcd shown in FIG. 6(a) is the average value of r(k) of Equation 32.

That is, no improvement can be made in estimation accuracy because the cause lies in the fact that even when the null signal is attempted to be decoded with the orthogonality having been lost, the output is not zero, and the cost function equation 40 becomes the minimum but it is not assured that v is the closest to the CFO. In this context, it is intended to find a cost function having a higher accuracy by determining a set of new subcarriers orthogonal to the matrix Ψ(k) of Equation 34.

<Estimation method for estimating both DCO and CFO>

What was not taken into account in the ME-TDA method was that DCO and CFO cause the loss of orthogonality to occur on OFDM signal subcarriers upon creating signals. The loss of orthogonality appeared in the terms other than the matrix d_{Q}(k) on the right-hand side of Equation 39. This is because although the matrix d_{Q}(k) can be said to have been affected by the frequency response during transmission, it is the transmitted signal itself. In this context, such a method will be shown for estimating both DCO and CFO in consideration of the loss of orthogonality. First, the very received signal was as shown in Equation 19. Equation 19 is shown below again.

[EQ 44]

r(k)=Γ_{N}(ε)W_{Q}d_{Q}(k)±βa (19)

Note that the matrix Γ_{N}(ε) is an N×N matrix and the matrix W_{Q} is an N×Q matrix. The matrix d_{Q}(k) and the β matrix a are both an N×l vertical vector. This can be explicitly shown in Equation 42 below.

$$\begin{matrix}[ EQ 45 ] & \\ r ( k ) = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ] [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] [ \begin{matrix}{d}_{1} ( k ) \\ {d}_{2} ( k ) \\ ⋮ \\ {d}_{Q} ( k )\end{matrix} ] + [ \begin{matrix}β \\ β \\ ⋮ \\ β\end{matrix} ] & ( 42 )\end{matrix}$$

Note that the matrix Γ_{N}(ε) is a diagonal matrix and represents the amount of CFO shift. Each element is as shown in Equation 13. Each element of the diagonal matrix was shown as Furthermore, the matrix W_{Q} is a matrix indicative of the conversion into subcarriers by OFDM and is shown in Equation 8. Each element was denoted as W_{N,Q}.

The matrix Γ_{N}(ε) and the matrix W_{Q} can be explicitly expressed by Equations 43 and 44 below.

$$\begin{matrix}[ EQ 46 ] & \\ \begin{matrix}{Γ}_{N} ( ɛ ) = [ \begin{matrix}1 & 0 & … & 0 \\ 0 & {e}^{j \frac{2 πɛ \cdot 1}{N}} & … & 0 \\ ⋮ & ⋮ & ⋱ & ⋮ \\ 0 & 0 & … & {e}^{j \frac{2 πɛ \cdot ( N - 1 )}{N}}\end{matrix} ] \\ = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ]\end{matrix} & ( 43 ) \\ [ EQ 47 ] & \\ {W}_{Q} = [ {w}_{1} , {w}_{2} , … , {w}_{Q} ] = [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] & ( 44 )\end{matrix}$$

The matrix d_{Q}(k) is originally the transmitted signal. The β is representative of the DCO component. The aforementioned equation is modified as in Equation 45 below.

$$\begin{matrix}[ EQ 48 ] & \\ \begin{matrix}r ( k ) = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ] [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] \\ [ \begin{matrix}{d}_{1} ( k ) \\ {d}_{2} ( k ) \\ ⋮ \\ {d}_{Q} ( k )\end{matrix} ] + [ \begin{matrix}β \\ β \\ ⋮ \\ β\end{matrix} ] \\ = [ \begin{matrix}{Γ}_{1 , 1} {w}_{1 , 1} & {Γ}_{1 , 1} {w}_{1 , 2} & … & {Δ}_{1 , 1} {w}_{1 , Q} \\ {Γ}_{2 , 2} {w}_{2 , 1} & {Γ}_{2 , 2} {w}_{2 , 2} & … & {Γ}_{2 , 2} {w}_{2 , Q} \\ ⋮ & ⋮ & ⋱ & ⋮ \\ {Γ}_{N , N} {w}_{N , 1} & {Γ}_{N , N} {w}_{N , 2} & … & {Γ}_{N , N} {w}_{N , Q}\end{matrix} ] [ \begin{matrix}{d}_{1} ( k ) \\ {d}_{2} ( k ) \\ ⋮ \\ {d}_{Q} ( k )\end{matrix} ] + [ \begin{matrix}β \\ β \\ ⋮ \\ β\end{matrix} ] \\ = [ \begin{matrix}{Γ}_{1 , 1} {w}_{1 , 1 ,} & {Γ}_{1 , 1} {w}_{1 , 2} & … & {Γ}_{1 , 1} {w}_{1 , Q} & 1 \\ {Γ}_{2 , 2} {w}_{2 , 1} & {Γ}_{2 , 2} {w}_{2 , 2} & … & {Γ}_{2 , 2} {w}_{2 , Q} & 1 \\ ⋮ & ⋮ & ⋱ & ⋮ & ⋮ \\ {Γ}_{N , N} {w}_{N , 1} & {Γ}_{N , N} {w}_{N , 2} & … & {Γ}_{N , N} {w}_{N , Q} & 1\end{matrix} ] [ \begin{matrix}{d}_{1} ( k ) \\ {d}_{2} ( k ) \\ ⋮ \\ {d}_{Q} ( k ) \\ β\end{matrix} ] \\ = [ Γ ( v ) W 1 ] {d}_{Q β} ( k )\end{matrix} & ( 45 )\end{matrix}$$

The matrix [ΓW1] was formed by further adding the DC component (vector with the elements being one) as a new carrier to the OFDM transmission characteristics (the inner product portion of the matrix Γ and the matrix W) with CFO occurring. Accordingly, β is also added as the DC component to the transmitted signal matrix d_{Q}(k) to form a matrix d_{Qβ}(k). The matrix [ΓW1] can be explicitly expressed by Equation 46 below.

$$\begin{matrix}[ EQ 49 ] & \\ [ Γ ( v ) W 1 ] = [ \begin{matrix}{Γ}_{1 , 1} {w}_{1 , 1} & {Γ}_{1 , 1} {w}_{1 , 2} & … & {Γ}_{1 , 1} {w}_{1 , Q} & 1 \\ {Γ}_{2 , 2} {w}_{2 , 1} & {Γ}_{2 , 2} {w}_{2 , 2} & … & {Γ}_{2 , 2} {w}_{2 , Q} & 1 \\ ⋮ & ⋮ & ⋱ & ⋮ & ⋮ \\ {Γ}_{N , N} {w}_{N , 1} & {Γ}_{N , N} {w}_{N , 2} & … & {Γ}_{N , N} {w}_{N , Q} & 1\end{matrix} ] & ( 46 )\end{matrix}$$

In other words, consider a new transmission system with a subcarrier having a frequency shift of ε from the original transmission system and a subcarrier for carrying the DC component. Furthermore, a new signal matrix d_{Qβ}(k) obtained by adding the DC component to the transmitted signal is also sent. The new signal matrix d_{Qβ}(k) is now considered to be sent by the matrix [ΓW1] transmission system with neither CFO nor DCO occurring. This modification has been made only by viewing differently the OFDM transmission status with the CFO and DCO occurring, and thus is the same as Equation 19 in contents.

Now, Here, a matrix Θ(v) is defined as in Equation 47 below.

[EQ 50]

Θ(v)=[Γ(ᵥ)W1] (47)

This matrix Θ(v) is an N×(Q+1) matrix. To dissolve such a matrix Θ(v) into several matrices, which contain an orthogonal matrix, a method called the singular value decomposition (SVD) method is available. According to the singular value decomposition method, the matrix Θ(v) is expressed as in Equation 48 below.

$$\begin{matrix}[ EQ 51 ] & \\ Θ ( v ) = U ( v ) Σ ( v ) V ( v ) = [ {U}_{S} ( v ) {U}_{Z} ( v ) ] [ \begin{matrix}{Σ}_{S} ( v ) \\ 0\end{matrix} ] {V}_{S} ( v ) & ( 48 )\end{matrix}$$

Here, a matrix U(v) is an N×N orthogonal square matrix. A matrix Uₛ(v) is an N×(Q+1) column matrix, and a matrix U_{Z}(v) is an N×(N−Q−1) column matrix. A matrix Σ(v) is an N×(Q+1) matrix. A matrix Σₛ(v) is a diagonal matrix with non-diagonal elements being zero. The diagonal element is called a singular value. In the matrix Σ(v), all the elements in its other portion are zero. A matrix Vₛ(v) is a (Q+1)×N row matrix with each row being orthogonal to another. That is, the relation of Equation 49 below holds true.

[EQ 52]

Vₛ^{H}(v)Vₛ(v)=I (49)

This singular value decomposition is similar to the eigenvalue decomposition; however, while the eigenvalue decomposition can only be applied to the square matrix, this is employed to decompose a non-square matrix into an orthogonal matrix and a diagonal matrix with non-diagonal elements being not zero.

The advantage of the singular value decomposition performed in this manner lies in that any column u_{Z,i}(v) in the matrix U_{Z}(v) can be extracted to multiply the matrix Θ(v) by its conjugate transposed matrix (1×N rows) from the left, allowing the result of the multiplication to be zero. That is, the relation holds true as in Equation 50 below.

$$\begin{matrix}[ EQ 53 ] & \\ \begin{matrix}{u}_{Z , i}^{ℋ} ( v ) [ Γ ( v ) W 1 ] = {u}_{Z , i}^{ℋ} Θ ( v ) \\ = {u}_{Z , i}^{ℋ} ( v ) [ {U}_{S} ( v ) {U}_{Z} ( v ) ] [ \begin{matrix}{Σ}_{S} ( v ) \\ 0\end{matrix} ] {V}_{S} ( v ) \\ = [ 0 … 0 ]\end{matrix} & ( 50 )\end{matrix}$$

More specifically, since the matrix U_{Z}(v) is an orthogonal matrix, its ith one column or the matrix u_{Z,i}(v) can be extracted and conjugate transposed to multiply the matrix U_{Z}(v) by the resulting matrix from the left, so that the multiplication of its own row yields one with the other being zero. More specifically, this is shown in Equation 51 below.

[EQ 54]

u_{Z,i}^{H}(v)U(v)=[0 . . . 010 . . .] (51)

Furthermore, since the matrix Uₛ(v) is an N×(Q+1) matrix, the aforementioned value “1” is found in the (Q+2)th or later from the beginning. Multiplying the matrix Σₛ(v) by this result can be expressed as in Equation 52 below.

$$\begin{matrix}[ EQ 55 ] & \\ [ \begin{matrix}0 & … & 010 & …\end{matrix} ] [ \begin{matrix}{Σ}_{S} ( v ) \\ 0\end{matrix} ] = [ 0 … 0 ] & ( 52 )\end{matrix}$$

Since the (Q+2)th row or later in the matrix Σₛ(v) contains elements being all zero, the resulting value “1” from Equation 51 is always multiplied by zero, yielding zero all the time. Furthermore, considering the matrix Σₛ(v) to be an N×(Q+1) matrix, the size of the matrix is 1×(Q+1). Equation 50 was obtained by multiplying this result by the matrix Vs(v). That is, because it is multiplied by a matrix with its elements being all zero, the multiplication yields a zero matrix even when the matrix VS(v) has any elements.

Accordingly, the input signal matrix r(k) multiplied by the matrix u_{Z,i}(v) extracted from the matrix U_{Z}(v) becomes zero under the condition that v=ε. More specifically, this is shown in Equation 53.

[EQ 56]

u_{Z,i}^{H}(v)r(k)=u_{Z,i}^{H}(v)[Γ(v)W1]d_{Qβ}(k)=u_{Z,i}^{H}Θ(v)d_{Qβ}(k)=0, v=ε (53)

The matrix u_{Z,i}(v) can be determined from the matrix Θ(v), and as shown with Equation 46, the matrix Θ(v) is made up of the matrix Γ_{N}(v) and the matrix W_{Q} to which a vector with the elements being one is added. Since these matrices can be determined from transmission system parameters, the matrix u_{Z,i}(v) can be pre-calculated for a variety of v.

Furthermore, in the aforementioned modification, it was assumed that the transmitting side transmitted a new transmitted signal matrix d_{Qβ}(k); however, since the receiving side can check only the received signal matrix r(k), the new transmitted signal matrix d_{Qβ}(k) needs not to be taken into account when considering the cost function.

After all, Equation 53 shows that the received signal with CFO and DCO occurring was successively multiplied by a series of pre-calculated values, thereby making it possible to obtain the cost function matrix u_{Z,i}(v) which is just zero where CFO is occurring.

This is a method which has been improved from the ME-TDA method shown in Equation 41. That is, it is possible to compensate for the average value of data over the symbol period regarded as the DCO, and further compensate Equation 53 for the CFO with the v determined as the cost function. This method is called the CNSE (Common Null Space base Estimator) method. As the Dcd shown in FIG. 6(b), the average value r(k) of Equation 32 is used.

On the other hand, Equation 53 was determined owing to the matrix U(v) obtained by the singular value decomposition of the matrix Θ(v) having a size of N×(Q+1). Such a matrix U(v) was realized because the matrix Θ(v) is not a square matrix. That is, in the IDFT matrix of the matrix F_{N}, the presence of a carrier carrying null allowed the matrix Θ(v) to be regarded as an N×(Q+1) matrix. In other words, this method cannot be used if carriers carrying null signals are not present in the OFDM transmission system. Note that the matrix G₂(v) will be discussed in detail below in the ACNS method.

### <ACNSE Method>

Using Equation 53 provides a compensation with improved accuracy. The CFO was estimated by Equation 53 with high accuracy though the average value r(k) of data over the symbol period was substituted for compensation of DCO. Accordingly, the CFO estimated here is used to estimate DCO again.

The aforementioned CFO is estimated as δ for the received signal of Equation 19, and the (Q+i)th subcarrier is further demodulated, which is expressed as in Equation 54 below.

$$\begin{matrix}[ EQ 57 ] & \\ \begin{matrix}{w}_{Q + i}^{ℋ} {E}_{N} ( δ ) r ( k ) = {w}_{Q + i}^{ℋ} {E}_{N} ( δ ) {Γ}_{N} ( ɛ ) {W}_{Q} {d}_{Q} ( k ) + β {w}_{Q + i}^{ℋ} {E}_{N} ( δ ) a \\ \approx β \times {w}_{Q + i}^{ℋ} {E}_{N} ( δ ) a\end{matrix} & ( 54 )\end{matrix}$$

Now, since δ can be regarded as being opposite in sign to and generally the same in magnitude as e, the first term in the first row on the right-hand side is generally zero. By the way, the first row on the left-hand side can take on known values by calculating or observing (specifically by receiving) all of them. Furthermore, the matrix w^{H}_{Q+i}, the matrix E_{N}(δ), and the matrix a of the second term of the first row on the right-hand side can also be calculated.

That is, only β of the second term of the first row on the right-hand side (=the second row) is unknown. In this context, first, a matrix y_{i,k} and a matrix x_{i,k} are defined as in Equations 55 and 56 below.

[EQ 58]

y_{i,k}=w_{Q+i}^{H}E_{N}(δ)r(k) (55)

[EQ 59]

I_{i,k}=w_{Q+i}^{H}E_{N}(δ)a (56)

Thus, Equation 54 can be expressed as “the matrix y_{i,k}=the β matrix x_{i,k}”. The matrix y_{i,k} and the matrix x_{i,k} which can satisfy that condition are present as many as the number of subcarriers carrying null. That is, there exist (N−Q) matrices. Accordingly, there exist (N−Q)×K equations in all that meet “the matrix y_{i,k}=the β matrix x_{i,k}”. These matrix y_{i,k} and matrix x_{i,k} are expressed as the column vector y and the column vector x. Using the least square method, β can be estimated as below. The estimated value of β is expressed as “βe”. This can be explicitly expressed as in Equation 57 below.

[EQ 60]

βₑ=(x^{H}x)⁻¹x^{H}y (57)

This “βe” can be said to have been estimated with higher accuracy than the average value r(k) of data over the symbol period because the value obtained by demodulating a subcarrier carrying null among the received signals after having compensated for CFO by the CNSE method is estimated as DCO. This “βe” is Dcd shown in the step (S1016) of FIG. 6(c). Note that it is also possible to estimate the CFO and DCO again by returning the “βe” value estimated here to the “β” value of Equation 19. The method for further estimating DCO based on the CNSE method in this manner is called the ACNSE (Advanced Common Null Space base Estimator) method.

Then, a more specific description will be made on the CFO estimation which has been used in the ACNSE method. To actually implement Equation 53, the matrix U(v) with varied v is prepared, so that the matrix r(k) or an observed value is multiplied by this matrix successively. That is, the inner product is calculated. In Equation 53, the conjugate transposed matrix of one column of the matrix U_{z}(v) was used; however, any column may be used as many as desired if it is a column of the matrix U_{Z}(v). That is, the relation holds true as in Equation 58.

$$\begin{matrix}[ EQ 61 ] & \\ {U}_{Z}^{ℋ} ( v ) r ( k ) = {U}_{Z}^{ℋ} ( v ) [ Γ ( v ) W 1 ] {d}_{Q β} ( k ) = [ \begin{matrix}0 \\ ⋮ \\ 0\end{matrix} ] , v = ɛ & ( 58 )\end{matrix}$$

A matrix U_{Z}^{H}(v) has an (N−Q−1)×N size. Here, a matrix having a collection of at least one or more row vectors extracted from the matrix U_{Z}^{H}(v) is considered as the matrix G₂(v) of FIG. 6. Equation 59 shows the G₂(v) having a collection of all the rows.

[EQ 62]

G₂(v)=U_{Z}^{H}(V) (59)

Then, v is CFO or ε where v is given when the norm value of the inner product of the matrix G₂(v) and the matrix r(k) is zero. If the value of v that can make Equation 53 zero cannot be found, then such v that allows Equation 53 to be at the minimum may be employed as the CFO estimate value.

A specific calculation is shown. The G₂(v) with respect to v is an (N−Q−1)×N matrix as shown above. This can be explicitly expressed as in Equation 60.

$$\begin{matrix}[ EQ 63 ] & \\ {G}_{2} ( v ) = [ \begin{matrix}{g}_{0 , 0} ( v ) & … & {g}_{N - 1 , 0} ( v ) \\ ⋮ & ⋱ & ⋮ \\ {g}_{0 , N - Q - 2} ( v ) & … & {g}_{N - 1 , N - Q - 2} ( v )\end{matrix} ] & ( 60 )\end{matrix}$$

The input signal was Equation 16. Equation 16 is shown below again.

[EQ 64]

r(k)=[r(kN), r(kN N+1), . . . , r(kN+N−1)]^{T} (16)

Substituting Equations 60 and 16 for Equation 58, the calculation of Equation 58 is expressed as in Equation 61 below.

$$\begin{matrix}[ EQ . 65 ] & \\ \begin{matrix}{G}_{2} ( v ) r ( k ) = [ \begin{matrix}{g}_{0 , 0} ( v ) & … & {g}_{N - 1 , 0} ( v ) \\ ⋮ & ⋱ & ⋮ \\ {g}_{0 , N - Q - 2} ( v ) & … & {g}_{N - 1 , N - Q - 2} ( v )\end{matrix} ] [ \begin{matrix}r ( kN ) \\ r ( kN + 1 ) \\ ⋮ \\ r ( kN + N - 1 )\end{matrix} ] \\ = [ \begin{matrix}{gr}_{0} \\ {gr}_{0} \\ ⋮ \\ {gr}_{N - Q - 2}\end{matrix} ]\end{matrix} & ( 61 )\end{matrix}$$

In this manner, the matrix G₂(v)r(k) can be determined as multiple values, but the total sum of these values may also be employed as the estimation value of the matrix G₂(v)r(k). That is, the values below are defined as a matrix Rav discussed with reference to FIG. 5. Furthermore, this will be the matrix Rav shown in FIGS. 6(b) and (c). This can be explicitly expressed as in Equation 62.

$$\begin{matrix}[ EQ 66 ] & \\ {R}_{av} = {\sum }_{i = 0}^{N - Q - 2} {‖ g {r}_{i} ‖}^{2} & ( 62 )\end{matrix}$$

In Equation 61, it may be acceptable to take the inner product of any column of the matrix G₂(v) and the input signal matrix r(k). This is because the column matrix of the matrix G₂(v) is originally a matrix having elements being zero and obtained by the singular value decomposition. Accordingly, all the N−Q−1 column matrices need not to be used but the number of columns may be chosen, as appropriate, depending on the computational speed of the operational unit (30) used. Furthermore, DCO may be calculated based on Equation 57.

Note that either of the CNSE method and the ACNSE method can employ the aforementioned matrix G₂(v). That is, the compensation section (17) of FIGS. 2 to 3 can employ any of these methods. Furthermore, some of these methods can be employed and switched over when used. Furthermore, according to the description of the present embodiment, CFO is normalized with the width of subcarriers; however, the frequency may also be directly used. Furthermore, in the calculation to minimize the result of Equation 53, it is not necessary to calculate all pieces of CFO check data if it can be said that the minimum value has been determined.

### [Implementation Example]

The compensation method of the present invention was simulated to confirm its effects. As the OFDM transmission system, the IEEE 802.11a WLAN standards were taken into account, with a bandwidth of 20 MHz, 64 subcarriers, a subcarrier interval of 20 M/64=0.3125 MHz, and a transfer rate of 12 Mbps. The modulation method employed was QPSK. The symbol length was 3.2 μsec, and the guard interval was 0.8 μsec. Of the 64 subcarriers, 12 subcarriers were assumed to carry null signals. The interval width of v was 0.01 (no unit). Accordingly, CFO was scanned at the intervals of 0.01×0.3125 M=3.125 kHz.

Since the number N of subcarriers is 64, Equation 35 can be used to determine the matrix Ω_{N}. Also, because 52 subcarriers carry non-null signals and which subcarriers do so has been determined, Equation 11 can also determine the matrix W_{Q}. Since the subcarrier interval and the interval width of v are known as described above, Equation 13 can also be used to determine the matrix Γ_{N}(v).

Accordingly, Equation 47 can be used to determine the matrix Θ(v). This makes it possible to determine the matrix U_{Z}(v) by the singular value decomposition. The matrix G₂(v) serving as CFO check data can be determined by Equation 59 as the conjugate transposed matrix of the matrix U_{Z}(v). The matrix G₂(v) is calculated in advance.

The received signal was created following the procedure below. First, transmitted waves were created by the OFDM scheme and given the effects of the frequency selective fading path, and the received signal (containing no CFO, DCO, and noise) was adjusted to have a power of 1. Thereafter, a predetermined CFO shift and DCO were given, and noise was added to thereby create the received signal.

Concerning the frequency selective fading, it was assume that the power of transmitted waves would exponentially decrease in accordance with Rayleigh scattering. It was also assumed that the signals having passed through their respective paths would reach the guard interval zone. Therefore, it was assumed that the phase shift in each path would evenly occur between zero and 2π.

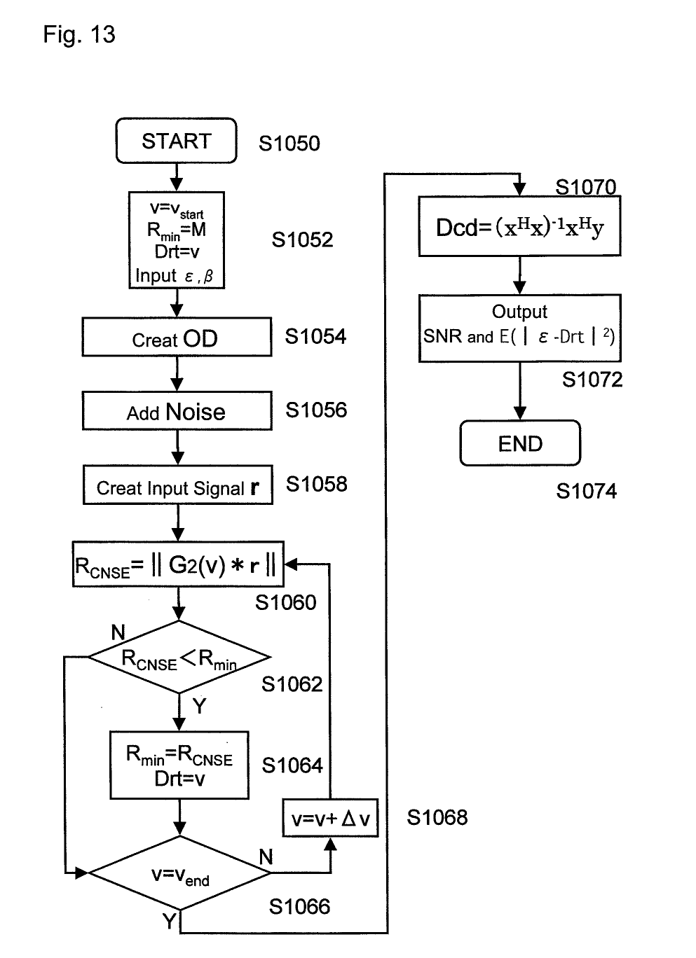

FIG. 13 shows the flow of the simulator of the present application. When the simulator starts (S1050), initial values is are set (S1052). Here, v is set to vₛₜₐᵣₜ. The vₛₜₐᵣₜ is the initial value for starting to explore CFO and typically depends on the LO characteristics. In the case of a carrier center frequency of 5 GHz, the process starts with −40 ppm*5 G/0.312 5M=−0.64 for +/−40 PPM LO. This simulator started with −0.64.

Rₘᵢₙ was set to an appropriate large value. Rₘᵢₙ is to be used as a variable for recording the minimum value of calculation results. Accordingly, it is sufficient to give a real numerical value equal to or greater than one as the initial value. Drt is set to the value of v. Drt is to store such v that is the closest to ε. The ε equivalent to CFO and the β equivalent to DCO are given in advance.

Next, original data OD is created (S1054). First, randomly generated QPSK signals are divided into groups of 52 signals and then subjected to a serial to parallel conversion; then, the respective 52 signals are associated with subcarriers and OFDM modulated by IFFT for a subsequent parallel to serial conversion. Here, the created digital information is the transmitted data. A guard interval was attached to this to define original data. According to Equation 1 of the embodiment, one of the original data or the OFDM symbol signal is the data of 64+16=80 samples along the time axis.

Next, noise is created (S1056). Concerning the noise, the power of an ideal signal was normalized to one, and white noise was added as power to it to obtain the desired SNR. The noise has a flat frequency characteristic.

Next, the input signal r to the simulator is created (S1058). The input signal r was created by giving the effects of the frequency selective fading path to the original data, shifting the frequency by ε or CFO, adding noise thereto, and added β or DCO thereto.

Next, the norm of the matrix G₂(v) and the input signal r was determined (S1060). This means that the inner product of the matrix G₂(v) and the input signal r is calculated, and the results are squared to take their total sum and then its square root. In this simulation, the column matrix of the matrix G₂(v) employed all the subcarriers carrying null data. Accordingly, the matrix G₂(v) is a 11×64 matrix. That is, the inner product of the matrix G(v) and r provides 11 elements as a result, while R_{CNSE} is obtained as the square root of the total sum of the square of each of these elements.

Then, R_{CNSE} and R_{MIN} are compared with each other (S1062). Here, if R_{CNSE} is less than R_{MIN}, then R_{CNSE} is employed as a new R_{MIN}, so that the v at this time is substituted for Drt (S1064). If R_{CNSE} is greater than R_{MIN}, then S1064 is skipped. By doing in this manner, R_{MIN} has the least calculated R_{NSE} stored and the v at that time is recorded as Drt.

Then, the process determines whether the v is the final one of those to be calculated (S1066). In this simulation, v_{end} is 0.64. If there remains another v to be calculated, the v is incremented by Δv (S1068) to calculate R_{CNSE} again. Here, Δv is an increment of 0.01.

After v has been completely calculated, DCO is then calculated (S1070). The DCO is calculated according to Equations 55 to 57. Equations 55 and 56 also have 5, which is equivalent to Drt.

Then, the process calculates the absolute value of the difference between ε and Drt, then outputs the resulting value together with SNR (S1072), and then ends (S1074).

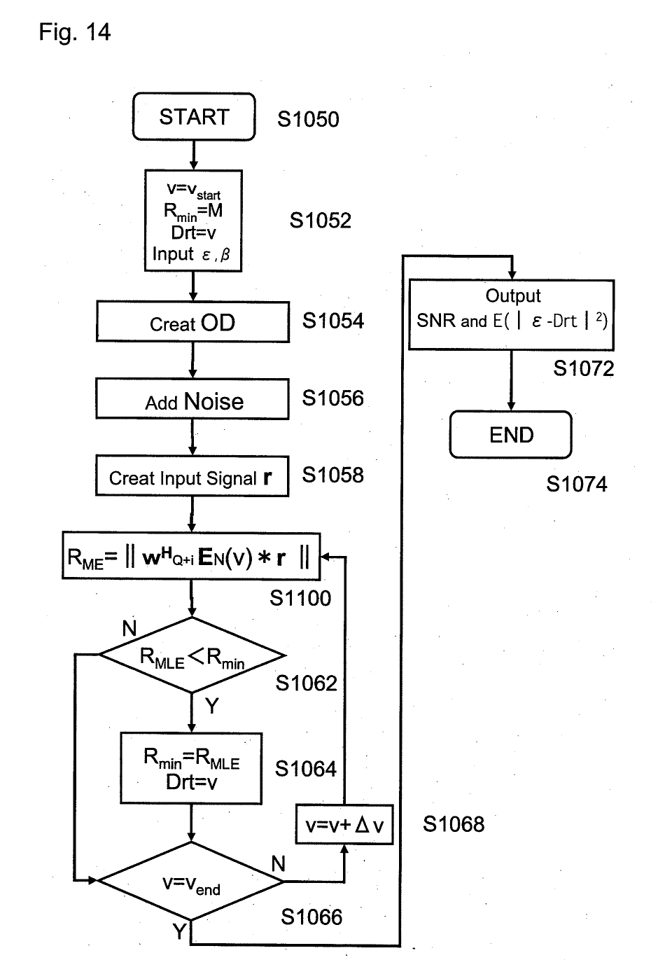

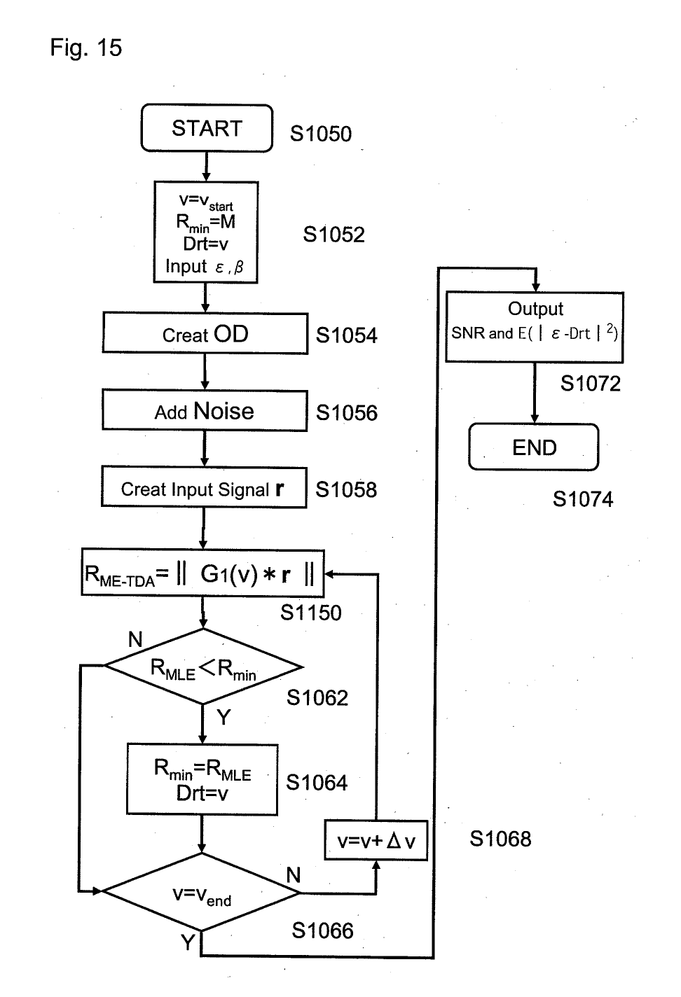

To compare the effects of the present invention, the ME method and the ME-TDA method were also simulated. Their flows are shown in FIG. 14 and FIG. 15, respectively.

The ME method employs almost the same flow as that of the present application but uses a different matrix to determine the inner product with the matrix r serving as the input signal in S1060 of the simulation of the present application. In this context, S1100 was employed. The matrix used here is the matrix shown as a specific example of Equation 27. Furthermore, the ME method cannot determine DOC, and thus has no such a step equivalent to the step (S1070) of the simulation of the present application.

The ME-TDA method is the same as the ME method but is different in the step of S1060 of the flow of the present application. The ME-TDA method employed it as the step (S1150). Here, it is the matrix G₁(v) that is used to determine the inner product with the input signal and which is the matrix illustrated in Equation 41.

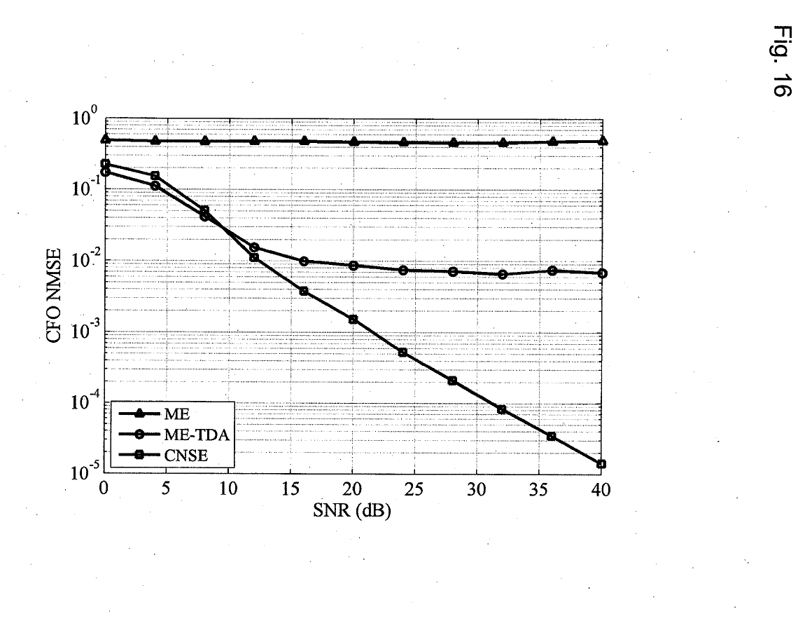

The simulator described above was used to calculate the differences between the estimation method of the present application, the ME method, and the ME-TDA method, as shown in FIG. 16. In FIG. 16, the vertical axis represents the square of the difference between c and Drt. NMSE stands for Normalized mean Sqogre error. The horizontal axis represents the SNR of the received signal, i.e., the input signal r for the simulator. The ε or CFO was 0.32, and β or DCO was so set that the square of β was 0.5. Note that β is given as a complex number.

An ε of 0.32 is equivalent to a CFO of 93.848 kHz. The triangle denotes the ME method, the circle indicating the ME-TDA method, and the square box showing the ACNSE method of the present invention. In the figure, the CNSE method is illustrated; however, the CNSE method and the ACNSE method are exactly the same in CFO estimation. When SNR takes on lower values, the three methods have not much difference; however, as the SNR takes on larger values, first, the CFO estimation by the ME method would not be improved any more. This is thought to be due to the fact that the ME method do not take DCO into account.

Furthermore, it is shown that the ME method can hardly estimate CFO even when the SNR of the received signal has increased. That is, it is shown that the ME method can provide an insufficient estimation of a CFO of the OFDM signal without the pilot signal.

Next, in the ME-TDA method, the estimation error becomes constant with the SNR being about 15 dB or greater. Although the ME-TDA method takes the DCO somehow into account, it cannot make the cost function zero in principle, and is thus limited in estimation.

It can be seen that in the ACNSE method, the estimate of CFO increasingly approaches the true value as the SNR becomes higher. Although the estimation method of the present invention cannot estimate CFO perfectly, its accuracy of estimation is extremely high when compared with the conventional methods.

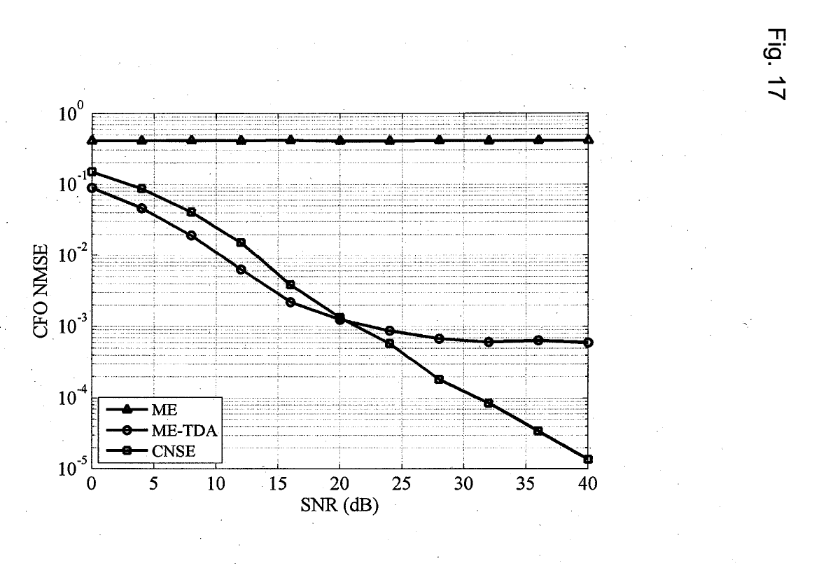

FIG. 17 shows the results when ε was set to 0.08 and p was set so that the square of β was 0.5. That is, DCO was not changed. In this case, the ME method can be said again to have not estimated CFO at all. On the other hand, the ME-TDA method can approach the true value up to about 20 dB in SNR. However, the estimate values do not approach the true value any more. In the CNSE method (ACNSE method), the CFO estimates increasingly approach the true value as SNR is improved.

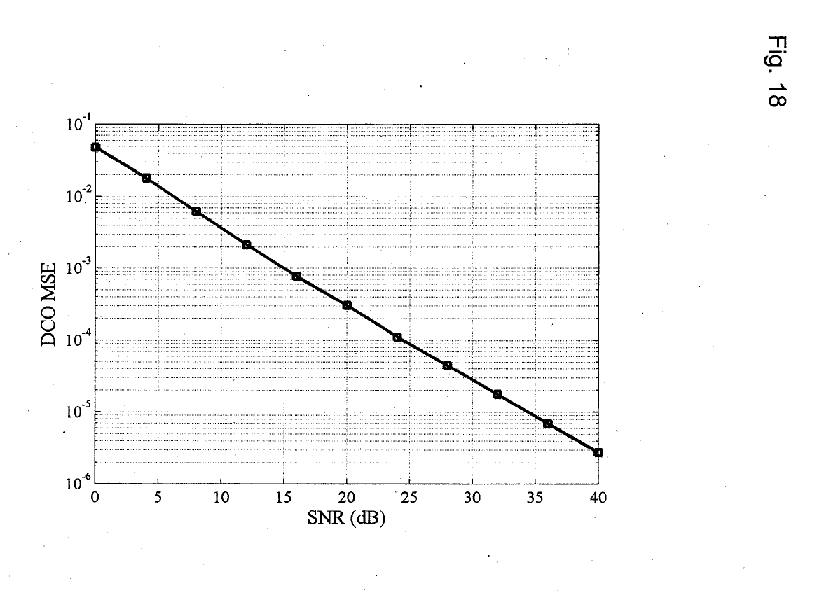

FIG. 18 shows the DCO estimation capability of the ACNSE method. In FIG. 18, the vertical axis represents the square of the difference between the true value and an estimate value of DCO. The horizontal axis represents the SNR of the input signal. In the ACNSE method, such an estimate can be provided which increasingly approaches the true value as the SNR of the input signal increases.

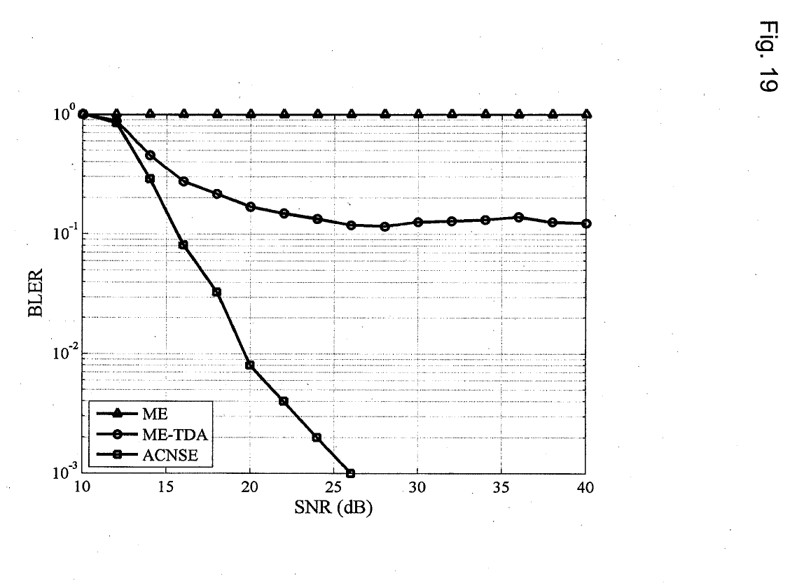

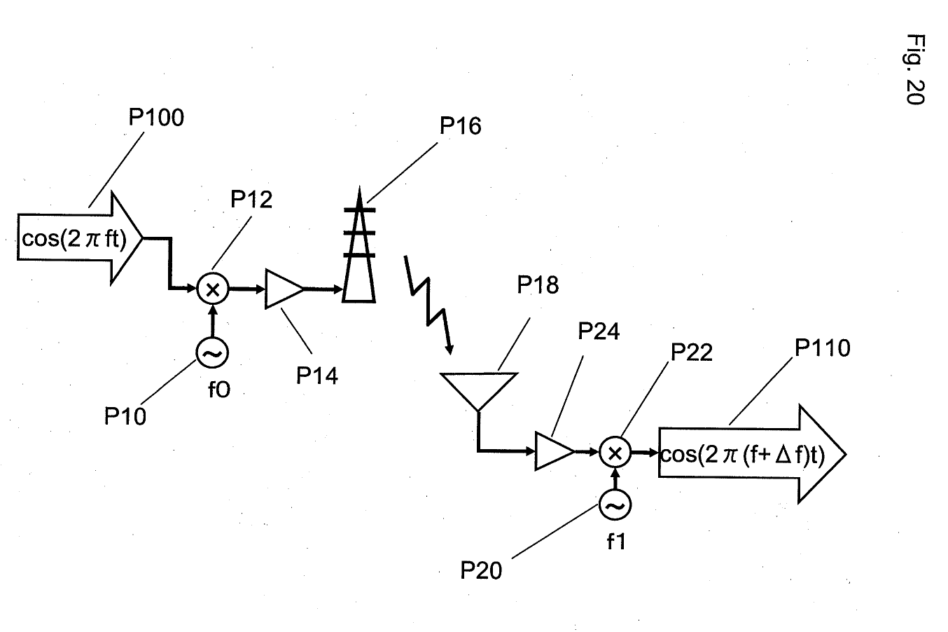

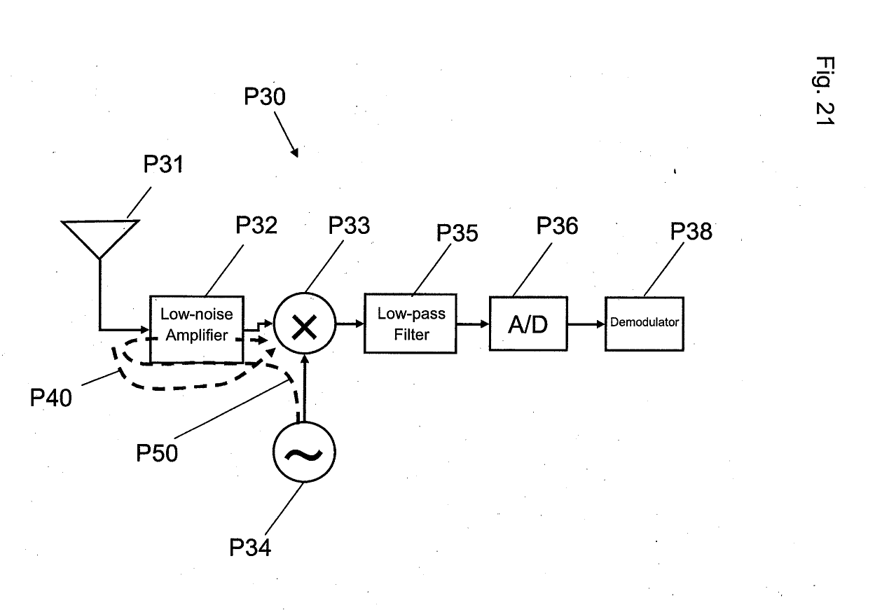

FIG. 19 shows the simulation results of block error rates. The vertical axis represents the block error rate, while the horizontal axis represents the SNR of the input signal. In the ME method, even if the SNR of the received signal increases, there will be no improvements in the block error rate. However, in the ME-TDA method and the ACNSE method, as the SNR of the received signal increases, the block error rate is also improved. As the measure of the block error rate, the block error rate corresponding to a length of 1000 bytes is desirably 10% or less.

In FIG. 19, in the. ME-TDA method, the block error rate is not 10% or less. However, as can be seen clearly in FIGS. 16 and 17, the estimation accuracy of CFO for the SNR of the received signal depends on the size of CFO. Accordingly, if the CFO has a large size, the ME-TDA method can also provide a block error rate of 10% or less. On the other hand, the ACNSE method has sufficient effects on the block error rate even if the CFO has a large size. As can be seen from the discussions above, the ME-TDA method, the CNSE method, and the ACNSE method of the present invention are a very useful compensation method when no pilot signal is available.

1-7. (canceled)

8. A method for compensating an OFDM signal, comprising the steps of:
acquiring data for one symbol of an OFDM received signal;
multiplying the data for one symbol by CFO check data selected from multiple sets of prepared CFO candidate values and a set of pieces of CFO check data corresponding to the CFO candidate values;
determining the CFO candidate value having a minimum result of the multiplication as a CFO estimate value; and
compensating the received signal by a frequency equivalent to the CFO estimate value, wherein
the CFO check data is a conjugate transposed matrix of a matrix including at least one or more column vectors selected from a matrix U_{Z}(v) of the matrix Θ(v), as expressed in the following equations;
$$\begin{matrix}[ EQ 100 ] & \\ [ EQ 100 ] & \\ {F}_{N} = \frac{1}{\sqrt{N}} [ \begin{matrix}1 & {e}^{j \frac{2 π \cdot 1 \cdot 0}{N}} & … & … & {e}^{j \frac{2 π \cdot ( N - 1 ) \cdot 0}{N}} \\ 1 & {e}^{j \frac{2 π \cdot 1 \cdot 1}{N}} & & & {e}^{j \frac{2 π \cdot ( N - 1 ) \cdot 1}{N}} \\ ⋮ & & ⋱ & & ⋮ \\ ⋮ & & & ⋱ & ⋮ \\ 1 & {e}^{j \frac{2 π \cdot 1 \cdot ( N - 1 )}{N}} & … & … & {e}^{j \frac{2 π \cdot ( N - 1 ) \cdot ( N - 1 )}{N}}\end{matrix} ] , & ( 5 ) \\ [ EQ 101 ] & \\ {W}_{Q} = [ {w}_{1} , {w}_{2} , … , {w}_{Q} ] = [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] , & ( 44 ) \\ [ EQ 102 ] & \\ \begin{matrix}{Γ}_{N} ( ɛ ) = [ \begin{matrix}1 & 0 & … & 0 \\ 0 & {e}^{j \frac{2 πɛ \cdot 1}{N}} & … & 0 \\ ⋮ & ⋮ & ⋱ & ⋮ \\ 0 & 0 & … & {e}^{j \frac{2 πɛ \cdot ( N - 1 )}{N}}\end{matrix} ] \\ = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ] ,\end{matrix} & ( 43 ) \\ [ EQ 103 ] & \\ [ Γ ( v ) W 1 ] = [ \begin{matrix}{Γ}_{1 , 1} {w}_{1 , 1} & {Γ}_{1 , 1} {w}_{1 , 2} & … & {Γ}_{1 , 1} {w}_{1 , Q} & 1 \\ {Γ}_{2 , 2} {w}_{2 , 1} & {Γ}_{2 , 2} {w}_{2 , 2} & … & {Γ}_{2 , 2} {w}_{2 , Q} & 1 \\ ⋮ & ⋮ & ⋱ & ⋮ & ⋮ \\ {Γ}_{N , N} {w}_{N , 1} & {Γ}_{N , N} {w}_{N , 2} & … & {Γ}_{N , N} {w}_{N , Q} & 1\end{matrix} ] , and & ( 46 ) \\ [ EQ 104 ] & \\ Θ ( v ) = U ( v ) Σ ( v ) V ( v ) = [ {U}_{S} ( v ) {U}_{Z} ( v ) ] [ \begin{matrix}{Σ}_{S} ( v ) \\ 0\end{matrix} ] {V}_{S} ( v ) , & ( 48 )\end{matrix}$$
where
a transformation to an OFDM signal matrix is a matrix F_{N} (Equation 5) with subcarriers being N in number,
when there are Q subcarriers carrying a non-null signal in the matrix F_{N}, a matrix W_{Q} (Equation 44) has a collection of the subcarriers,
a matrix Γ(v) (Equation 43) shifts a frequency by the CFO candidate value v,
a matrix [Γ(v)W1] (Equation 46) is configured in a manner such that a column vector with all elements being one is added to a matrix resulting from an inner product of the matrix Γ(v) and the matrix W_{Q}, and
a Θ(v) (Equation 48) is obtained by a singular value decomposition of the matrix [Γ(v)W1].

9. The method for compensating an OFDM signal according to claim 8, comprising the steps of:
compensating the received signal by a frequency equivalent to the CFO estimate value and determining a value obtained by demodulating a subcarrier carrying null as a DCO estimate value; and
compensating for a DCO with the DCO estimate value.

10. The method for compensating an OFDM signal according to claim 8, comprising the steps of:
determining an arithmetic mean of the data for one symbol as a DCO estimate value; and
compensating for a DCO with the DCO estimate value.

11. An OFDM signal receiver comprising:
a memory device for storing multiple sets of prepared CFO candidate values and a set of pieces of CFO check data corresponding to the CFO candidate values; and
a compensation section for multiplying the CFO check data by an inputted OFDM received signal, for determining the CFO candidate value having a minimum result of the multiplication as a CFO estimate value, and for compensating the received signal by a frequency equivalent to the CFO estimate value, wherein
the CFO check data is a conjugate transposed matrix of a matrix including at least one or more column vectors selected from a matrix U_{Z}(v) of the matrix Θ(v), as expressed in the following equations;
$$\begin{matrix}[ EQ 105 ] & \\ {F}_{N} = \frac{1}{\sqrt{N}} [ \begin{matrix}1 & {e}^{j \frac{2 π \cdot 1 \cdot 0}{N}} & … & … & {e}^{j \frac{2 π \cdot ( N - 1 ) \cdot 0}{N}} \\ 1 & {e}^{j \frac{2 π \cdot 1 \cdot 1}{N}} & & & {e}^{j \frac{2 π \cdot ( N - 1 ) \cdot 1}{N}} \\ ⋮ & & ⋱ & & ⋮ \\ ⋮ & & & ⋱ & ⋮ \\ 1 & {e}^{j \frac{2 π \cdot 1 \cdot ( N - 1 )}{N}} & … & … & {e}^{j \frac{2 π \cdot ( N - 1 ) \cdot ( N - 1 )}{N}}\end{matrix} ] , & ( 5 ) \\ {W}_{Q} = [ {w}_{1} , {w}_{2} , … , {w}_{Q} ] = [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] , & ( 44 ) \\ [ EQ 106 ] & \\ \begin{matrix}{Γ}_{N} ( ɛ ) = [ \begin{matrix}1 & 0 & … & 0 \\ 0 & {e}^{j \frac{2 πɛ \cdot 1}{N}} & … & 0 \\ ⋮ & ⋮ & ⋱ & ⋮ \\ 0 & 0 & … & {e}^{j \frac{2 πɛ \cdot ( N - 1 )}{N}}\end{matrix} ] \\ = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ] ,\end{matrix} & ( 43 ) \\ [ EQ 107 ] & \\ [ Γ ( v ) W 1 ] = [ \begin{matrix}{Γ}_{1 , 1} {w}_{1 , 1} & {Γ}_{1 , 1} {w}_{1 , 2} & … & {Γ}_{1 , 1} {w}_{1 , Q} & 1 \\ {Γ}_{2 , 2} {w}_{2 , 1} & {Γ}_{2 , 2} {w}_{2 , 2} & … & {Γ}_{2 , 2} {w}_{2 , Q} & 1 \\ ⋮ & ⋮ & ⋱ & ⋮ & ⋮ \\ {Γ}_{N , N} {w}_{N , 1} & {Γ}_{N , N} {w}_{N , 2} & … & {Γ}_{N , N} {w}_{N , Q} & 1\end{matrix} ] , and & ( 46 ) \\ [ EQ 108 ] & \\ Θ ( v ) = U ( v ) Σ ( v ) V ( v ) = [ {U}_{S} ( v ) {U}_{Z} ( v ) ] [ \begin{matrix}{Σ}_{S} ( v ) \\ 0\end{matrix} ] {V}_{S} ( v ) , & ( 48 )\end{matrix}$$
where
a transformation to an OFDM signal matrix is a matrix F_{N} (Equation 5) with subcarriers being N in number,
when there are Q subcarriers carrying a non-null signal in the matrix F_{N}, a matrix W_{Q} (Equation 44) has a collection of the subcarriers,
a matrix Γ(v) (Equation 43) shifts a frequency by the CFO candidate value v,
a matrix [Γ(v)W1] (Equation 46) is configured in a manner such that a column vector with all elements being one is added to a matrix resulting from an inner product of the matrix Γ(v) and the matrix W_{Q}, and
a η(v) (Equation 48) is obtained by a singular value decomposition of the matrix [Γ(v)W1].

12. A program for executing the steps of:
acquiring data for one symbol of an OFDM received signal;
multiplying the data for one symbol by CFO check data selected from multiple sets of prepared CFO candidate values and a set of pieces of CFO check data corresponding to the CFO candidate values:
determining the CFO candidate value having a minimum result of the multiplication as a CFO estimate value; and
compensating the received signal by a frequency equivalent to the CFO estimate value, wherein
the CFO check data is a conjugate transposed matrix of a matrix including at least one or more column vectors selected from a matrix U_{Z}(v) of the matrix Θ(v), as expressed in the following equations;
$$\begin{matrix}[ EQ 110 ] & \\ {F}_{N} = \frac{1}{\sqrt{N}} [ \begin{matrix}1 & {e}^{j \frac{2 π \cdot 1 \cdot 0}{N}} & … & … & {e}^{j \frac{2 π \cdot ( N - 1 ) \cdot 0}{N}} \\ 1 & {e}^{j \frac{2 π \cdot 1 \cdot 1}{N}} & & & {e}^{j \frac{2 π \cdot ( N - 1 ) \cdot 1}{N}} \\ ⋮ & & ⋱ & & ⋮ \\ ⋮ & & & ⋱ & ⋮ \\ 1 & {e}^{j \frac{2 π \cdot 1 \cdot ( N - 1 )}{N}} & … & … & {e}^{j \frac{2 π \cdot ( N - 1 ) \cdot ( N - 1 )}{N}}\end{matrix} ] , & ( 5 ) \\ [ EQ 111 ] & \\ {W}_{Q} = [ {w}_{1} , {w}_{2} , … , {w}_{Q} ] = [ \begin{matrix}{w}_{1 , 1} & {w}_{1 , 2} & … & {w}_{1 , Q} \\ {w}_{2 , 1} & ⋱ & & ⋮ \\ ⋮ & & ⋱ & ⋮ \\ {w}_{N , 1} & … & … & {w}_{N , Q}\end{matrix} ] , & ( 44 ) \\ [ EQ 112 ] & \\ \begin{matrix}{Γ}_{N} ( ɛ ) = [ \begin{matrix}1 & 0 & … & 0 \\ 0 & {e}^{j \frac{2 π ɛ \cdot 1}{N}} & … & 0 \\ ⋮ & ⋮ & ⋱ & ⋮ \\ 0 & 0 & … & {e}^{j \frac{2 π ɛ \cdot ( N - 1 )}{N}}\end{matrix} ] \\ = [ \begin{matrix}{Γ}_{1 , 1} & 0 & … & 0 \\ 0 & {Γ}_{2 , 2} & … & 0 \\ ⋮ & ⋮ & ⋱ & ⋮ \\ 0 & 0 & … & {Γ}_{N , N}\end{matrix} ] ,\end{matrix} & ( 43 ) \\ [ EQ 113 ] & \\ [ Γ ( v ) W 1 ] = [ \begin{matrix}{Γ}_{1 , 1} {w}_{1 , 1} & {Γ}_{1 , 1} {w}_{1 , 1} & … & {Γ}_{1 , 1} {w}_{1 , Q} & 1 \\ {Γ}_{2 , 2} {w}_{2 , 1} & {Γ}_{2 , 2} {w}_{2 , 2} & … & {Γ}_{2 , 2} {w}_{2 , Q} & 1 \\ ⋮ & ⋮ & ⋱ & ⋮ & ⋮ \\ {Γ}_{N , N} {w}_{N , 1} & {Γ}_{N , N} {w}_{N , 2} & … & {Γ}_{N , N} {w}_{N , Q} & 1\end{matrix} ] , and & ( 46 ) \\ [ EQ 114 ] & \\ Θ ( v ) = U ( v ) Σ ( v ) V ( v ) = [ {U}_{S} ( v ) {U}_{Z} ( v ) ] [ \begin{matrix}{Σ}_{S} ( v ) \\ 0\end{matrix} ] {V}_{S} ( v ) , & ( 48 )\end{matrix}$$
where
a transformation to an OFDM signal matrix is a matrix F_{N} (Equation 5) with subcarriers being N in number,
when there are Q subcarriers carrying a non-null signal in the matrix F_{N}, a matrix W_{Q} (Equation 44) has a collection of the subcarriers,
a matrix Γ(v) (Equation 43) shifts a frequency by the CFO candidate value v,
a matrix [Γ(v)W1] (Equation 46) is configured in a manner such that a column vector with all elements being one is added to a matrix resulting from an inner product of the matrix Γ(v) and the matrix W_{Q}, and
a Θ(v) (Equation 48) is obtained by a singular value decomposition of the matrix [Γ(v)W1].

13. A recording medium on which the program according to claim 12 is recorded.
